(19) United States
(12) Patent Application Publication
(10) Pub. No.: US 2026/0058880 A1
(43) Pub. Date: Feb. 26, 2026

(54) METHOD FOR DATA COLLECTION FOR SPATIAL DOMAIN BEAM PREDICTIONS

(71) Applicant: Telefonaktiebolaget LM Ericsson (publ), Stockholm (SE)

(72) Inventors: Jingya LI, Göteborg (SE); Andreas NILSSON, Göteborg (SE); Daniel CHEN LARSSON, Lund (SE); Icaro Leonardo DA SILVA, Solna (SE); Chunhui LI, Yokohama (JP); Henrik RYDÉN, Stockholm (SE)

(21) Appl. No.: 19/101,430

(22) PCT Filed: Aug. 11, 2023
(86) PCT No.: PCT/SE2023/050810

§ 371 Date: Feb. 5, 2025

Related U.S. Application Data
(60) Provisional application No. 63/397,169, filed on Aug. 11, 2022.

(51) Int. Cl. H04L 41/16; H04B 7/06; H04W 24/10

(52) U.S. Cl. CPC H04L 41/16; H04B 7/06968; H04W 24/10

(57) ABSTRACT

A method, system and apparatus are disclosed. A wireless device is provided. Wireless device is configured to perform measurements on at least one first reference signal resource and at least one second reference signal of a plurality of reference signal resources indicated by a reference signal configuration, the measurements being performed based on a measurement report configuration associated with the plurality of reference signal resources. The wireless device is configured to store the measurements for at least one of training and monitoring a machine learning, ML, model configured to predict at least one of at least one best beam and at least one K-best beam associated with at least one downlink, DL, reference signal transmitted by the network node.

### TECHNICAL FIELD

The present disclosure relates to wireless communications, and in particular, to data collection for spatial domain beam predictions.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. The 3GPP is also working to develop standards for Sixth Generation (6G) wireless communication systems. Such systems provide, among other features, broadband communication between network nodes, such as base stations, and mobile wireless devices (WD), as well as communication between network nodes and between WDs.

### Beam Management Procedures

In a high frequency range (e.g., FR2), multiple radio frequency (RF) beams may be used to transmit and receive signals at a network node (e.g., gNB) and a wireless device (e.g., user equipment (UE)). For each downlink (DL) beam from a network node, there is typically an associated best wireless device receive (Rx) beam for receiving signals from the DL beam. The DL beam and the associated wireless device Rx beam forms a beam pair. The beam pair can be identified through a so-called beam management process in NR.

A DL beam may be identified by an associated DL reference signal (RS) transmitted in the beam, which may, for example, be periodically, semi-persistently, or aperiodically transmitted. The DL RS may be, for example, a Synchronization Signal (SS) and Physical Broadcast Channel (PBCH) block (SSB), a Channel State Information RS (CSI-RS), etc. By measuring all the DL RSs, the wireless device may determine and report to the network node the best DL beam to use for DL transmissions. The network node may then transmit a burst of DL RS in the reported best DL beam to enable the wireless device to evaluate candidate wireless device Rx beams.

For example, beam management may be divided into the three example procedures schematically illustrated in FIG. 1:

A first procedure, P-1, may be used for finding a coarse direction for the wireless device, e.g., using a wide network node transmit (Tx) beam covering the whole angular sector.

A second procedure, P-2, may be used for refining the network node Tx beam, e.g., by performing a new beam search around the coarse direction found in P-1.

A third procedure, P-3, may be used for a wireless device that has analog beamforming, e.g., to enable the wireless device to find a suitable wireless device Rx beam.
P-1 may be expected to utilize beams with relatively large beamwidths and where the beam reference signals are transmitted periodically and are shared between all wireless devices of the cell. Example reference signals used for P-1 include periodic CSI-RS or SSB. The wireless device may then report the N best beams to the network node along with their corresponding RSRP values.
P-2 may be expected to use aperiodic and/or semi-persistent CSI-RS transmitted in narrow beams around the coarse direction found in P-1.
P-3 may be expected to use aperiodic and/or semi-persistent CSI-RSs repeatedly transmitted in one narrow network node beam. Alternatively, the wireless device may determine a suitable wireless device Rx beam based on the periodic SSB transmission. Since each SSB consists of four orthogonal frequency-division multiplexing (OFDM) symbols, a maximum of four wireless device Rx beams may be evaluated during each SSB burst transmission. One benefit with using SSB instead of CSI-RS is that no extra overhead of CSI-RS transmission is needed.

### Beam Indication

In NR, several signals may be transmitted from different antenna ports of a same network node (e.g., a base station). These signals may have the same large-scale properties, e.g., Doppler shift/spread, average delay spread, average delay, etc. These antenna ports may be considered to be quasi co-located (QCL).

If the wireless device knows that two antenna ports are QCL with respect to a certain parameter (e.g., Doppler spread), the wireless device may estimate that parameter based on one of the antenna ports and apply that estimate for receiving signal on the other antenna port.

For example, there may be a QCL relation between a CSI-RS for a Tracking RS (TRS) and the physical downlink shared channel (PDSCH) demodulation reference signal (DMRS). When the wireless device receives the PDSCH DMRS it may use the measurements already made on the TRS to assist with the DMRS reception.

Information about what assumptions can be made regarding QCL may be signaled to the wireless device from the network node. In some existing NR systems, for example, four types of QCL relations between a transmitted source RS and transmitted target RS have been defined:
Type A: {Doppler shift, Doppler spread, average delay, delay spread}
Type B: {Doppler shift, Doppler spread}
Type C: {average delay, Doppler shift}
Type D: {Spatial Rx parameter}

QCL type D was introduced in NR to facilitate beam management with analog beamforming and is known as spatial QCL. There is currently no strict definition of spatial QCL, but the understanding is that if two transmitted antenna ports are spatially QCL, the wireless device may use the same Rx beam to receive them. This may be helpful for a wireless device that uses analog beamforming to receive signals, since the wireless device may need to adjust its Rx beam in some direction prior to receiving a certain signal. If the wireless device knows that the signal is spatially QCL with some other signal it has received earlier, then it may be able to safely use the same Rx beam to also receive this signal.

In NR, the spatial QCL relation for a DL or UL signal/channel may be indicated to the wireless device by using a “beam indication”. The “beam indication” may be used to help the wireless device to find a suitable Rx beam for DL reception, and/or a suitable Tx beam for UL transmission. In NR, the “beam indication” for DL may be conveyed to the wireless device (e.g., by the network node) by indicating a transmission configuration indicator (TCI) state to the wireless device, while in UL the “beam indication” may be conveyed, e.g., by indicating a DL-RS or UL-RS as spatial relation (e.g., as in NR Rel-15/16) and/or a TCI state (e.g., as in NR Rel-17).

### Beam Management With Unified TCI Framework

In NR, downlink beam management may be performed by conveying spatial QCL (‘Type D’) assumptions to the wireless device through TCI states.

In NR Rel-15 or Rel-16, for physical downlink control channel (PDCCH), the network node may configure the wireless device with a set of PDCCH TCI states by radio resource configuration (RRC), and then may activate one TCI state per Control Resource Set (CORESET) using Medium Access Control (MAC) Control Element (CE). For physical downlink shared channel (PDSCH) beam management, the network node may configure the wireless device with a set of PDSCH TCI states by RRC, and then may activate up to 8 TCI states by MAC CE. After activation, the network node may dynamically indicate one of these activated TCI states using a TCI field in downlink control information (DCI) when scheduling PDSCH.

Such a framework may allow flexibility for the network to instruct the wireless device to receive signals from different spatial directions in DL, but with a cost of large signaling overhead and slow beam switching. These limitations may be particularly noticeable and costly when wireless device movement is considered. For example, a beam update using DCI may only be performed for PDSCH, and MAC-CE and/or RRC signaling may be required to update the beam for other reference signals/channels, which may cause extra overhead and latency.

Furthermore, it may often be the case that the network node transmits to and receives from a wireless device in the same direction for both data and control. Hence, using a separate framework (e.g., TCI state respective spatial relations) for different channels/signals may add undesirable complication in existing systems.

In NR Rel-17, a common beam framework was introduced to simplify beam management in FR2, in which a common beam represented by a TCI state may be activated/indicated to a wireless device and the common beam may be applicable for multiple channels/signals such as PDCCH and PDSCH. The common beam framework is also referred to as a unified TCI state framework.

The NR-17 framework may be RRC configured in one of two modes of operation, i.e., “Joint DL/UL TCI” or “Separate DL/UL TCI”. For “Joint DL/UL TCI”, one common Joint TCI state may be used for both DL and UL signals/channels. For “Separate DL/UL TCI”, one common DL-only TCI state may be used for DL channels/signals and one common UL-only TCI state is used for UL signals/channels.

A unified TCI state may be updated in a similar way as the TCI state update for PDSCH in Rel-15/16, i.e., with one of two alternatives:

Two-stage: RRC signaling is used to configure a number of unified TCI states in higher layer parameter PDSCH-config, and a MAC-CE is used to activate one of unified TCI states

Three-stage: RRC signaling is used to configure a number of unified TCI states in PDSCH-config, a MAC-CE is used to activate up to 8 unified TCI states, and a 3-bit TCI state bitfield in DCI is used to indicate one of the active unified TCI states

The one activated or indicated unified TCI state may be used in subsequent PDCCH and PDSCH transmissions until a new unified TCI state is activated or indicated.

The existing DCI formats 1_1 and 1_2 may be reused for beam indication, both with and without DL assignment. For DCI formats 1_1 and 1_2 with DL assignment, Acknowledgment/Negative Acknowledgment (ACK/NACK) of the PDSCH may be used as indication of successful reception of beam indication. For DCI formats 1_1 and 1_2 without DL assignment, a ACK/NACK mechanism analogous to that for semi-persistent scheduling (SPS) PDSCH release with both type-1 and type-2 Hybrid automatic repeat request (HARQ)-ACK codebook may be used, where, upon a successful reception of the beam indication DCI, the wireless device reports an ACK.

For DCI-based beam indication in some existing systems, the first slot to apply the indicated TCI is at least Y symbols after the last symbol of the acknowledgment of the joint or separate DL/UL beam indication. The Y symbols may be configured by the network node based on wireless device capability, which may also be reported in units of symbols. The values of Y may not be determined in existing systems.

### Reference Signal Configurations

CSI-RS: A CSI-RS may be transmitted over each Tx antenna port at the network node and for different antenna ports. The CSI-RS may be multiplexed in time, frequency, and code domains such that the channel between each Tx antenna port at the network node and each receive antenna port at a wireless device may be measured by the wireless device. The time-frequency resource used for transmitting CSI-RS is referred to as a CSI-RS resource.

In some existing NR systems, the CSI-RS for beam management is defined as a 1- or 2-port CSI-RS resource in a CSI-RS resource set where the filed repetition is present. The following three types of CSI-RS transmissions are supported in some existing systems:

Periodic CSI-RS: CSI-RS is transmitted periodically in certain slots. This CSI-RS transmission is semi-statically configured using RRC signaling with parameters such as CSI-RS resource, periodicity, and/or slot offset.

Semi-Persistent CSI-RS: Similar to periodic CSI-RS, resources for semi-persistent CSI-RS transmissions are semi-statically configured using RRC signaling with parameters such as periodicity and slot offset. However, unlike periodic CSI-RS, dynamic signaling may be needed to activate and deactivate the CSI-RS transmission.

Aperiodic CSI-RS: aperiodic CSI-RS is a “one-shot” CSI-RS transmission that may occur in any one of a plurality of slots. Here, “one-shot” may refer CSI-RS transmission which only happens once per trigger. The CSI-RS resources (i.e., the resource element (RE) locations which consist of subcarrier locations and OFDM symbol locations) for aperiodic CSI-RS are semi-statically configured. The transmission of aperiodic CSI-RS may be triggered by dynamic signaling through PDCCH using the CSI request field in UL DCI, in the same DCI where the UL resources for the measurement report are scheduled. Multiple aperiodic CSI-RS resources may be included in a CSI-RS resource set and the triggering of aperiodic CSI-RS is on a resource set basis.

SSB: In some existing NR systems, an SSB consists of a pair of synchronization signals (SSs), physical broadcast channel (PBCH), and DMRS for PBCH. A SSB may be mapped to 4 consecutive OFDM symbols in the time domain and 240 contiguous subcarriers (20 resource blocks (RBs)) in the frequency domain.

To support beamforming and beam-sweeping for SSB transmission, in some existing NR systems, a cell may transmit multiple SSBs in different narrow-beams in a time multiplexed fashion. The transmission of these SSBs may be confined to a half frame time interval (5 ms). It may also be possible to configure a cell to transmit multiple SSBs in a single wide-beam with multiple repetitions. The design of beamforming parameters for each of the SSBs within a half frame may vary depending on network implementation. The SSBs within a half frame may be broadcasted periodically from each cell. The periodicity of the half frames with SS/PBCH blocks is referred to as SSB periodicity, which may be indicated by system information block 1 (SIB1), for example.

The maximum number of SSBs within a half frame, denoted by L, may depend on the frequency band, and the time locations for these L candidate SSBs within a half frame may depend on the SCS of the SSBs. The L candidate SSBs within a half frame are indexed in an ascending order in time from 0 to L-1. By successfully detecting PBCH and its associated DMRS, a wireless device may determine the SSB index. A cell does not necessarily transmit SS/PBCH blocks in all L candidate locations in a half frame, and the resource of the un-used candidate positions may be used for the transmission of data or control signaling instead. Network implementations may vary regarding which candidate time locations to select for SSB transmission within a half frame, and which beam to use for each SSB transmission.

### Measurement Resource Configurations

In some existing NR systems, a wireless device may be configured with N≥1 channel state information (CSI) reporting settings (i.e., CSI-ReportConfig), M≥1 resource settings (i.e., CSI-ResourceConfig), where each CSI reporting setting is linked to one or more resource setting for channel and/or interference measurement. The CSI framework is modular, meaning that several CSI reporting settings may be associated with the same Resource Setting.

The measurement resource configurations for beam management may be provided to the wireless device by RRC information (IEs) CSI-ResourceConfigs. One CSI-ResourceConfig contains several non-zero-power (NZP)-CSI-RS-ResourceSets and/or CSI-SSB-ResourceSets.

For example, in some existing systems, a wireless device may be configured to perform measurement on CSI-RSs. Here, the RRC information element (IE) NZP-CSI-RS-ResourceSet may be used. A NZP CSI-RS resource set contains the configuration of Ks≥1 CSI-RS resources, where the configuration of each CSI-RS resource includes at least: mapping to Res, the number of antenna ports, time-domain behavior, etc. Up to 64 CSI-RS resources can be grouped to a NZP-CSI-RS-ResourceSet. A wireless device can also be configured to perform measurements on SSBs. Here, the RRC IE CSI-SSB-ResourceSet is used. Resource sets comprising SSB resources are defined in a similar manner.

In the case of aperiodic CSI-RS and/or aperiodic CSI reporting, the network node configures the wireless device with Sc CSI triggering states. Each triggering state contains the aperiodic CSI report setting to be triggered along with the associated aperiodic CSI-RS resource sets.

In some existing systems, periodic and semi-persistent Resource Settings may only include a single resource set (i.e., S=1) while S>=1 for aperiodic Resource Settings. In the aperiodic case, one out of the S resource sets included in the Resource Setting may be indicated by the aperiodic triggering state that triggers a CSI report.

### Measurement Reporting

Three types of CSI reporting are supported in some existing NR systems, as follows:

Periodic CSI Reporting on PUCCH: CSI is reported periodically by a wireless device. Parameters such as periodicity and slot offset are configured semi-statically by higher layer RRC signaling from the network node to the wireless device.

Semi-Persistent CSI Reporting on PUSCH or PUCCH: similar to periodic CSI reporting, semi-persistent CSI reporting has a periodicity and slot offset which may be semi-statically configured. However, a dynamic trigger from network node to wireless device may be needed to allow the wireless device to begin semi-persistent CSI reporting. A dynamic trigger from network node to wireless device is needed to request the wireless device to stop the semi-persistent CSI reporting.

Aperiodic CSI Reporting on PUSCH: This type of CSI reporting involves a single-shot (i.e., one time) CSI report by a wireless device which is dynamically triggered by the network node using DCI. Some of the parameters related to the configuration of the aperiodic CSI report is semi-statically configured by RRC but the triggering is dynamic

In each CSI reporting setting, the content and time-domain behavior of the report is defined, along with the linkage to the associated Resource Settings. The CSI-ReportConfig IE may include the following configurations:
reportConfigType—Defines the time-domain behavior, i.e., periodic CSI reporting, semi-persistent CSI reporting, or aperiodic CSI reporting, along with the periodicity and slot offset of the report for periodic CSI reporting.
reportQuantity—Defines the reported CSI parameter(s) (i.e., the CSI content), such as PMI, CQI, RI, L1 (layer indicator), CRI (CSI-RS resource index) and L1-RSRP. Only a certain number of combinations are possible (e.g., ‘cri-RI-PMI-CQI’ is one possible value and ‘cri-RSRP’ is another) and each value of reportQuantity could be said to correspond to a certain CSI mode.
codebookConfig—Defines the codebook used for PMI reporting, along with possible codebook subset restriction (CBSR). Two “Types” of PMI codebook are defined in NR, Type I CSI and Type II CSI, each codebook type further has two variants each.
reportFrequencyConfiguration—Define the frequency granularity of PMI and CQI (wideband or subband), if reported, along with the CSI reporting band, which is a subset of subbands of the bandwidth part (BWP) which the CSI corresponds to Measurement restriction in time domain (ON/OFF) for channel and interference, respectively.

For beam management, a wireless device may be configured to report L1-RSRP for up to four different CSI-RS/SSB resource indicators. The reported RSRP value corresponding to the first (best) CRI/SSBRI requires 7 bits, using absolute values, while the others require 4 bits using encoding relative to the first. In NR release 16, for example, the report of L1-SINR for beam management is supported

### Beam Prediction

One example artificial intelligence (AI)/machine learning (ML) (AI/ML)-model in the AI for air-interface (e.g., in some NR Rel-18 systems) includes predicting the channel with respect to a beam for a certain time-frequency resource. The expected performance of such predictor depends on several different aspects, for example time/frequency variation of channel due to wireless device mobility or changes in the environment. Due to the inherit correlation in time, frequency and the spatial domain of the channel, an ML-model can be trained to exploit such correlations. The spatial domain can include of different beams, where the correlation properties partly depend on the how the network node (e.g., gNB) antennas form the different beams, and how the wireless device forms the receiver beams.

The device may use such prediction ML-model to reduce its measurement related to beamforming. In some existing NR systems, a device may be requested to measure on a set of SSB beams or/and CSI-RS beams. A stationary device typically experiences less variations in beam quality in comparison to a moving device. The stationary device can therefore save battery and reduce the number of beam measurements by instead using an ML model to predict the beam quality without an explicit measurement. It can do this, for example, by measuring a subset of the beams and predicting the rest of the beams. For example, in some instances, using AI/ML measurements on a subset of beams in order to predict the best beam may reduce measurement time, e.g., by up to 75%.

Existing systems have considered enabling a wireless device to predict future beam values based on historical values. Based on received device data from measurement reports, the network node can learn, for example, which sequences of signal quality measurements (e.g., RSRP measurements) lead to large signal quality drop events (e.g., turning around the corners as illustrated in FIG. 2). This learning procedure may be enabled, for example, by dividing periodically reported RSRP data into a training and prediction window.

In the example shown in FIG. 2, two wireless devices 120a and 120b in communication with network node 110 move and turn around the same corner. The path of wireless device 120b, marked by dashed line, is the first to turn around the corner and experience a large signal quality drop. It may be possible to mitigate the drop of a second wireless device (120a) by using learning from the first device 120b's experiences.

The learning may be done by feeding RSRP in t₁, . . . , tₙ into a machine learning model (e.g., neural network), and then learn the RSRP in tₙ₊₁, tₙ₊₂. After the model is trained, the network node may then predict future signal quality values, and the signal quality prediction can then be used, e.g., to avoid radio-link failure, or beam failure, e.g., by:
Initiating inter-frequency handover;
Setting handover/reselection parameters;
Pre-emptively performing candidate beam selection to avoid beam failure; and
Changing device scheduler priority, for example, schedule a device when the expected signal quality is good.

Existing systems have considered AI/ML based spatial beam prediction for a Set A of beams based on measurement results of Set B of beams. The Set B of beams may either be a subset of the Set A of beams, or the Set A of beams could have different beams compared to the Set B of beams (for example Set A consists of narrow beams and Set B consists of wide beams). The spatial beam prediction could either be made by the network node (e.g., gNB) side or at the wireless device (e.g., UE) side.

Existing systems, however, may lack adequate data/data collection sufficient to perform AI/ML based spatial beam prediction for a Set A of beams based on measurement results of Set B of beams.

### SUMMARY

With the introduction of new features with each new release of NR, the amount of CSI measurements the wireless device is configured to perform and to report is increasing. With deployment in higher frequencies, as in some existing 5G NR systems, this amount is even higher, as the wireless device may be configured to perform measurements on resources (DL RSs, e.g., SSBs and/or CSI-RSs) transmitted in multiple spatial domain directions (e.g., DL RSs transmitting using spatial domain filters), which may be called DL transmission (Tx) beams or simply beams transmitted by the network node.

Performing more CSI measurements may increase the wireless device energy consumption and, if these measurements are based on DL RSs, the network node transmits primarily for that purpose (e.g., CSI-RSs for beam measurements), that may result in an increased overhead in wireless network transmissions and increased level of interference. Also, more DL RSs/beams to be measured may lead to an increased delay in performing CSI measurements at the wireless device, which may lead to delays in making CSI measurements available for being reported. Longer delays to make CSI measurements available may lead to a risk of failure in the connection, such as beam failure detection (BFD) and/or Radio Link Failure (RLF), as the wireless device may be trying to report to the network node that the current beam (e.g., the DL RS associated to the currently activated TCI State) has poor quality or that there is a much better beam (e.g., another DL RS associated to another TCI State) available, so that if that takes too long, it may be too late for the network to trigger a beam switching command (e.g., MAC CE indicating a new TCI state to be activated), and thus a failure may occur. Thus, it may be beneficial if the wireless device could reduce the CSI measurements performed, but still provide timely and accurate information to the network about the quality of beams the network may use to serve the wireless device.

Spatial domain prediction of beams is one technique for reducing the CSI measurements for beam management which a wireless device is required to perform, e.g., based on an AI/ML function at the wireless device and/or network node. One example DL spatial AI/ML-based beam prediction method is to select one or more beams from a Set A of DL Tx beams (which the network node may use to serve the wireless device, and associated with one or more TCI states the wireless device is configured with) based on measurements on a Set B of DL Tx beams (e.g., wherein measurements are on DL RSs transmitted in these beams within Set B), where the Set B of beams are different than the Set A of beams (for example, the Set B of beams are wide beams and the Set A of beams are narrow beams, or Set B is a subset of Set A).

Existing systems may lack procedures for performing (offline) model training for network node-sided and/or wireless device-sided DL spatial domain beam prediction. The term “offline” in this context may refer to an AI/ML model first being trained at an entity in order to make it capable of predicting the Set A of beams based on measurements on the Set B of beams (i.e., a model training phase). The trained AI/ML model is then deployed either at the wireless device side and/or at the network node side (i.e., a model deployment phase), where the AI/ML model is used to perform beam prediction (i.e., model inference phase). The entity that performs model training may be the same as the entity that performs model inference, or an AI/ML model may be trained at one entity and then deployed/used at another entity.

Thus, existing systems may lack procedures for (offline) model training for network node-sided and/or wireless device-sided DL spatial domain beam prediction, e.g., data collection procedures for (offline) model training, for example, in 3GPP wireless communication networks. For instance, existing systems may lack procedures for configuring DL-RS resources to enable measurement data collection, may lack procedures for how to indicate the rules for the AI/ML model training (e.g., how Set A and Set B will be configured for model training and inference), if needed, and may lack procedures for determining when and how to trigger and perform new data collection.

According to some embodiments of the present disclosure, a method at a wireless device and/or a network node for performing/enabling data collection for (offline) training of an AI/ML model for DL spatial beam prediction is provided, for example, for predicting a Set A of DL Tx beams based on CSI measurements of a Set B of DL Tx beams, wherein the Set A and Set B are different (e.g., the Set B of beams are wide beams and the Set A of beams are narrow beams, or Set B is a subset of Set A).

In some embodiments, the method includes the wireless device receiving (e.g., from a network node) a configuration of one or more resource configuration(s), such as DL Reference Signal(s) configuration(s), for DL RSs transmitted by the network (e.g., SSBs and/or CSI-RS resources) in one or more spatial directions (e.g., using spatial filter(s)) on which the wireless device may perform one or more CSI measurements.

In some embodiments, the term “data collection” may refer to the wireless device receiving the configuration, performing the CSI measurements according to the configuration, and/or providing these CSI measurements (or information derived from the measurements, e.g., one or more beam identifiers and/or DL RS identifiers) to an entity for AI/ML model training. The collected data is used by the model training entity to create training data set(s) to train an AI/ML model that can perform spatial-domain prediction. The model training entity may be located at either the wireless-device side or the network node (and/or core network and/or host computer and/or cloud-based server) side.

Embodiments of the present disclosure may also provide a method wherein the network node designs/determines the configuration(s) for the DL-RS resources for data collection, for example, based on where the model training entity/functionality is located (e.g., at the wireless device side or at the network node side).

The method may further include the network node providing assistance information to the wireless device for the cases where the model training entity/functionality is located at the wireless device side. The assistance information includes, e.g., the network node antenna configuration identity and/or the configuration of Set A and Set B for model training.

Embodiments of the present disclosure may perform one or more actions in response to various different triggering events for initiating data collection for (offline) model training and wireless device capability reporting related to its support of data collection for spatial domain beam prediction.

Some embodiments advantageously provide methods, systems, and apparatuses for data collection for spatial domain beam predictions.

One or more embodiments of the present disclosure may beneficially enable data collection of spatial beam prediction at either the wireless device and/or the network node side, such as in a 5G NR system.

One or more embodiments of the present disclosure may enable the wireless device and/or network node to perform data collection (e.g., measurements performed on the DL RSs configured by the network node) and to train (and/or re-train or update) an AI/ML model at the wireless device (and/or in the network node) for performing spatial-domain prediction of beams.

In cases where the model is possibly re-trained/trained/updated/etc. as the wireless device moves (e.g., changes cell, location, area, etc.), one or more embodiments of the present disclosure may enable an improved inference performance over existing systems, as it may be possible to re-train an AI/ML model while the wireless device is in an active state (e.g., RRC_CONNECTED).

In one or more embodiments of the present disclosure, spatial-domain prediction of beams, i.e., predicting the quality of a Set A of beams based on measurements performed on another Set B (which may or not overlap with the Set A), may enable the wireless device to perform fewer measurements, which may beneficially reduce the wireless device's energy consumption compared to existing systems. In addition, if these measurements are based on DL RSs which the network node may transmit primarily for that purpose (e.g., CSI-RSs for beam measurements), embodiments of the present disclosure may provide a beneficial reduction of transmission overhead in the wireless network and/or reduction in the interference compared to existing systems.

One or more embodiments of the present disclosure may offer the advantage that fewer DL RSs and/or beams need to be measured by the wireless device, which consequently may mean that CSI measurements and/or information derived based on the measurements to be reported to the network node may be available much faster compared to existing systems, which may decrease the delay for obtaining CSI measurements for reporting. Shorter delays to make CSI measurements available may beneficially reduce the risk of failure in the connection, such as beam failure detection (BFD) and/or Radio Link Failure (RLF), as compared to existing systems, as the wireless device may be able to report more quickly that a current beam (e.g., the DL RS associated to the currently activated TCI State) has poor quality and/or that there is a better beam (e.g., another DL RS associated to another TCI State) available, enabling the response from the network node to be more timely for triggering a beam switching command (e.g., a MAC CE indicating a new TCI state to be activated), and thus a failure may be avoided in some embodiments of the present disclosure. Thus, it may be beneficial that the wireless device reduces the CSI measurements performed, but still provides timely and accurate information to the network node about the quality of beams the network node may use to serve the wireless device.

According to one aspect of the present disclosure, a network node is provided. Network node is configured to transmit a reference signal configuration to the wireless device, the reference signal configuration configuring at least one first reference signal resource and at least one second reference signal of a plurality of reference signal resources indicated by a reference signal configuration. Network node is configured to receive, from the wireless device, a measurement report including measurements performed based on a measurement report configuration associated with the plurality of reference signal resources, the measurements being used for at least one of training and monitoring a machine learning, ML, model configured to predict at least one of at least one best beam and at least one K-best beam associated with at least one downlink, DL, reference signal transmitted by the network node.

According to one or more embodiments of this aspect, the network node is further configured to: configure the wireless device to determine not to transmit a measurement report to the network node based on the measurement report configuration.

According to one or more embodiments of this aspect, the measurement report is based on the measurement report configuration at least one predicted signal metric for the at least one second reference signal resource.

According to one or more embodiments of this aspect, the at least one first reference signal resource is associated with a first spatial direction, and the at least one second reference signal resource is associated with a second spatial direction different from the first spatial direction.

According to one or more embodiments of this aspect, the at least one first reference signal resource belongs to a first reference signal resource set, which is associated with a first set of beams, and the at least one second reference signal resource belongs to a second reference signal resource set, which is associated with a second set of beams different from the first set of beams.

According to one or more embodiments of this aspect, the measurement report contains one of the best Y reference signal or the best Y reference signals with the highest RSRP values from the first reference signal resource set, the second reference signal resource set, or both.

According to one or more embodiments of this aspect, the first set of beams includes at least one narrow beam, and the second set of beams includes at least one wide beam that is spatially wider than the at least one narrow beam.

According to one or more embodiments of this aspect, the first set of beams includes only narrow beams, and the second set of beams includes only wide beams.

According to one or more embodiments of this aspect, the first set of beams includes at least one wide beam, and the second set of beams includes at least one narrow beam.

According to one or more embodiments of this aspect, the first set of beams includes only wide beams, and the second set of beams includes only narrow beams.

According to one or more embodiments of this aspect, network node is further configured to: receive a data collection request; and at least one of: the signal configuration being received based at least on the data collection request; or the measurement report configuration being received based at least on the data collection request.

According to one or more embodiments of this aspect, the data collection request indicates at least one of: the at least one first reference signal resource to be measured; the at least one second reference signal resource to be predicted; a machine learning, ML, model processing capability; a prediction capability; a limitation on a relationship between a first number of the at least one of first reference signal resources and a second number of the at least one second reference signal resources; at least one network node antenna configuration for data collection; or a request for assistance from the network node for training of the ML model.

According to one or more embodiments of this aspect, the at least one first reference signal resource is associated with a first cell, and the at least one second reference signal resource is associated with a second cell different from the first cell.

According to one or more embodiments of this aspect, the wireless device is configured with a dual connectivity configuration, the first cell being a secondary cell, SCell, of the dual connectivity configuration, the first cell being a special cell, sPCell, of the dual connectivity configuration.

According to one or more embodiments of this aspect, the at least one first reference signal resource is associated with a first cell, and the at least one second reference signal resource is associated with the first cell.

According to one or more embodiments of this aspect, network node is further configured to: transmit, to the wireless device, an indication indicating at least one of a spatial correlation or quasi-co-location, QCL, relation between the at least one first reference signal resource and the at least one second reference signal resource; and the training of the ML model being further based on at least one of the spatial correlation or the QCL relation.

According to one or more embodiments of this aspect, network node is further configured to: receive a first indication that the training of the ML model is complete; in response to the first indication, transmit a second indication to the wireless device indicating that the network node has stopped transmitting at least one of the at least one first reference signal resource or the at least one second reference signal resource; and the second indication being configured to cause the wireless device to at least one of deactivate and remove at least one of the at least one first reference signal resource or the at least one second reference signal resource.

According to one or more embodiments of this aspect, network node is further configured to: determine that the wireless device has moved from a first location to a second location; and based on the determination, retrain the ML model using at least one additional measurement of the at least one first reference signal resource measured at the second location.

According to one or more embodiments of this aspect, the at least one first reference signal resource includes at least one of: a synchronization signal block, SSB, resource; a channel state information reference signal, CSI-RS, resource; a cell-specific reference signal, CRS, resource; a discovery reference signal, DRS, resource; or a demodulation reference signal, DMRS, resource; and the at least one second reference signal resource includes at least one of: an SSB resource; a CSI-RS resource; a CRS resource; a DRS resource; or a DMRS resource.

According to one or more embodiments of this aspect, the plurality of reference signal resources includes at least of: a periodic resource having a configured periodicity; an aperiodic resource; or a semi-persistent aperiodic resource having a configured periodicity.

According to one or more embodiments of this aspect, network node is further configured to: receive measurements performed on the at least one first reference signal resource of the plurality of reference signal resources at least one of: upon the wireless device transitioning to an RRC_CONNECTED state from either of a RRC_IDLE state or RRC_INACTIVE state; or as part of a handover procedure.

According to one aspect of the present disclosure, a method performed by a network node is provided. The method includes transmitting a reference signal configuration to the wireless device, the reference signal configuration configuring at least one first reference signal resource and at least one second reference signal of a plurality of reference signal resources indicated by a reference signal configuration. The method includes receiving, from the wireless device, a measurement report including measurements performed based on a measurement report configuration associated with the plurality of reference signal resources, the measurements being used for at least one of training and monitoring a machine learning, ML, model configured to predict at least one of at least one best beam and at least one K-best beam associated with at least one downlink, DL, reference signal transmitted by the network node.

According to one or more embodiments of this aspect, the method includes configuring the wireless device to determine not to transmit a measurement report to the network node based on the measurement report configuration.

According to one or more embodiments of this aspect, the measurement report is based on the measurement report configuration at least one predicted signal metric for the at least one second reference signal resource.

According to one or more embodiments of this aspect, the at least one first reference signal resource is associated with a first spatial direction, and the at least one second reference signal resource is associated with a second spatial direction different from the first spatial direction.

According to one or more embodiments of this aspect, the at least one first reference signal resource belongs to a first reference signal resource set, which is associated with a first set of beams, and the at least one second reference signal resource belongs to a second reference signal resource set, which is associated with a second set of beams different from the first set of beams.

According to one or more embodiments of this aspect, the measurement report contains one of the best Y reference signal or the best Y reference signals with the highest RSRP values from the first reference signal resource set, the second reference signal resource set, or both.

According to one or more embodiments of this aspect, the first set of beams includes at least one narrow beam, and the second set of beams includes at least one wide beam that is spatially wider than the at least one narrow beam.

According to one or more embodiments of this aspect, the first set of beams includes only narrow beams, and the second set of beams includes only wide beams.

According to one or more embodiments of this aspect, the first set of beams includes at least one wide beam, and the second set of beams includes at least one narrow beam.

According to one or more embodiments of this aspect, the first set of beams includes only wide beams, and the second set of beams includes only narrow beams.

According to one or more embodiments of this aspect, method includes: receiving a data collection request; and at least one of: the signal configuration being received based at least on the data collection request; or the measurement report configuration being received based at least on the data collection request.

According to one or more embodiments of this aspect, the data collection request indicates at least one of: the at least one first reference signal resource to be measured; the at least one second reference signal resource to be predicted; a machine learning, ML, model processing capability; a prediction capability; a limitation on a relationship between a first number of the at least one of first reference signal resources and a second number of the at least one second reference signal resources; at least one network node antenna configuration for data collection; or a request for assistance from the network node for training of the ML model.

According to one or more embodiments of this aspect, the at least one first reference signal resource is associated with a first cell, and the at least one second reference signal resource is associated with a second cell different from the first cell.

According to one or more embodiments of this aspect, the wireless device is configured with a dual connectivity configuration, the first cell being a secondary cell, SCell, of the dual connectivity configuration, the first cell being a special cell, sPCell, of the dual connectivity configuration.

According to one or more embodiments of this aspect, the at least one first reference signal resource is associated with a first cell, and the at least one second reference signal resource is associated with the first cell.

According to one or more embodiments of this aspect, method includes: transmitting, to the wireless device, an indication indicating at least one of a spatial correlation or quasi-co-location, QCL, relation between the at least one first reference signal resource and the at least one second reference signal resource; and the training of the ML model being further based on at least one of the spatial correlation or the QCL relation.

According to one or more embodiments of this aspect, method includes: receiving a first indication that the training of the ML model is complete; in response to the first indication, transmitting a second indication to the wireless device indicating that the network node has stopped transmitting at least one of the at least one first reference signal resource or the at least one second reference signal resource; and the second indication being configured to cause the wireless device to at least one of deactivate and remove at least one of the at least one first reference signal resource or the at least one second reference signal resource.

According to one or more embodiments of this aspect, method includes: determining that the wireless device has moved from a first location to a second location; and based on the determination, retraining the ML model using at least one additional measurement of the at least one first reference signal resource measured at the second location.

According to one or more embodiments of this aspect, the at least one first reference signal resource includes at least one of: a synchronization signal block, SSB, resource; a channel state information reference signal, CSI-RS, resource; a cell-specific reference signal, CRS, resource; a discovery reference signal, DRS, resource; or a demodulation reference signal, DMRS, resource; and the at least one second reference signal resource includes at least one of: an SSB resource; a CSI-RS resource; a CRS resource; a DRS resource; or a DMRS resource.

According to one or more embodiments of this aspect, the plurality of reference signal resources includes at least of: a periodic resource having a configured periodicity; an aperiodic resource; or a semi-persistent aperiodic resource having a configured periodicity.

According to one or more embodiments of this aspect, method includes: receiving measurements performed on the at least one first reference signal resource of the plurality of reference signal resources at least one of: upon the wireless device transitioning to an RRC_CONNECTED state from either of a RCC_IDLE state or RRC_INACTIVE state; or as part of a handover procedure.

According to one aspect of the present disclosure, a wireless device is provided. Wireless device is configured to perform measurements on at least one first reference signal resource and at least one second reference signal of a plurality of reference signal resources indicated by a reference signal configuration, the measurements being performed based on a measurement report configuration associated with the plurality of reference signal resources. Wireless device is configured to store the measurements for at least one of training and monitoring a machine learning, ML, model configured to predict at least one of at least one best beam and at least one K-best beam associated with at least one downlink, DL, reference signal transmitted by the network node.

According to one or more embodiments of this aspect, wireless device is further configured to: determine not to transmit a measurement report to the network node based on the measurement report configuration.

According to one or more embodiments of this aspect, wireless device is further configured to: determine a measurement report based on the measurement report configuration and at least one predicted signal metric for the at least one second reference signal resource; and transmit the measurement report to the network node.

According to one or more embodiments of this aspect, the at least one first reference signal resource is associated with a first spatial direction, and the at least one second reference signal resource is associated with a second spatial direction different from the first spatial direction.

According to one or more embodiments of this aspect, the at least one first reference signal resource belongs to a first reference signal resource set, which is associated with a first set of beams, and the at least one second reference signal resource belongs to a second reference signal resource set, which is associated with a second set of beams different from the first set of beams.

According to one or more embodiments of this aspect, the measurement report contains one of the best Y reference signal or the best Y reference signals with the highest RSRP values from the first reference signal resource set, the second reference signal resource set, or both.

According to one or more embodiments of this aspect, the first set of beams includes at least one narrow beam, and the second set of beams includes at least one wide beam that is spatially wider than the at least one narrow beam.

According to one or more embodiments of this aspect, the first set of beams includes only narrow beams, and the second set of beams includes only wide beams.

According to one or more embodiments of this aspect, the first set of beams includes at least one wide beam, and the second set of beams includes at least one narrow beam.

According to one or more embodiments of this aspect, the first set of beams includes only wide beams, and the second set of beams includes only narrow beams.

According to one or more embodiments of this aspect, wireless device is further configured to: cause transmission to the network node of a data collection request; and at least one of: the signal configuration being received based at least on the data collection request; or the measurement report configuration being received based at least on the data collection request.

According to one or more embodiments of this aspect, the data collection request indicates at least one of: the at least one first reference signal resource to be measured; the at least one second reference signal resource to be predicted; a machine learning, ML, model processing capability; a prediction capability; a limitation on a relationship between a first number of the at least one of first reference signal resources and a second number of the at least one second reference signal resources; at least one network node antenna configuration for data collection; or a request for assistance from the network node for training of the ML model.

According to one or more embodiments of this aspect, the at least one first reference signal resource is associated with a first cell, and the at least one second reference signal resource is associated with a second cell different from the first cell.

According to one or more embodiments of this aspect, the wireless device is configured with a dual connectivity configuration, the first cell being a secondary cell, SCell, of the dual connectivity configuration, the first cell being a special cell, sPCell, of the dual connectivity configuration.

According to one or more embodiments of this aspect, the at least one first reference signal resource is associated with a first cell, and the at least one second reference signal resource is associated with the first cell.

According to one or more embodiments of this aspect, the wireless device is further configured to: receive an indication indicating at least one of a spatial correlation or quasi-co-location, QCL, relation between the at least one first reference signal resource and the at least one second reference signal resource; and the training of the ML model being further based on at least one of the spatial correlation or the QCL relation.

According to one or more embodiments of this aspect, the wireless device is further configured to: cause transmission to the network node of a first indication that the training of the ML model is complete; in response to the first indication, receive a second indication from the network node indicating that the network node has stopped transmitting at least one of the at least one first reference signal resource or the at least one second reference signal resource; and in response to the second indication, at least one of deactivate and remove at least one of the at least one first reference signal resource or the at least one second reference signal resource.

According to one or more embodiments of this aspect, the wireless device is further configured to: determine that the wireless device has moved from a first location to a second location; and based on the determination, retrain the ML model using at least one additional measurement of the at least one first reference signal resource measured at the second location.

According to one or more embodiments of this aspect, the at least one first reference signal resource includes at least one of: a synchronization signal block, SSB, resource; a channel state information reference signal, CSI-RS, resource; a cell-specific reference signal, CRS, resource; a discovery reference signal, DRS, resource; or a demodulation reference signal, DMRS, resource; and the at least one second reference signal resource includes at least one of: an SSB resource; a CSI-RS resource; a CRS resource; a DRS resource; or a DMRS resource.

According to one or more embodiments of this aspect, the plurality of reference signal resources includes at least of: a periodic resource having a configured periodicity; an aperiodic resource; or a semi-persistent aperiodic resource having a configured periodicity.

According to one or more embodiments of this aspect, the wireless device is further configured to: perform measurements on the at least one first reference signal resource of the plurality of reference signal resources at least one of: upon the wireless device transitioning to an RRC_CONNECTED state from either of a RRC_IDLE state or RRC_INACTIVE state; or as part of a handover procedure

According to one aspect of the present disclosure, a method performed by a wireless device is provided. The method includes performing measurements on at least one first reference signal resource and at least one second reference signal of a plurality of reference signal resources indicated by a reference signal configuration, the measurements being performed based on a measurement report configuration associated with the plurality of reference signal resources. The method includes storing the measurements for at least one of training and monitoring a machine learning, ML, model configured to predict at least one of at least one best beam and at least one K-best beam associated with at least one downlink, DL, reference signal transmitted by the network node.

According to one or more embodiments of this aspect, the method includes: determining not to transmit a measurement report to the network node based on the measurement report configuration.

According to one or more embodiments of this aspect, the method includes determining a measurement report based on the measurement report configuration and at least one predicted signal metric for the at least one second reference signal resource; and transmit the measurement report to the network node.

According to one or more embodiments of this aspect, the at least one first reference signal resource is associated with a first spatial direction, and the at least one second reference signal resource is associated with a second spatial direction different from the first spatial direction.

According to one or more embodiments of this aspect, the at least one first reference signal resource belongs to a first reference signal resource set, which is associated with a first set of beams, and the at least one second reference signal resource belongs to a second reference signal resource set, which is associated with a second set of beams different from the first set of beams.

According to one or more embodiments of this aspect, the measurement report contains one of the best Y reference signal or the best Y reference signals with the highest RSRP values from the first reference signal resource set, the second reference signal resource set, or both.

According to one or more embodiments of this aspect, the first set of beams includes at least one narrow beam, and the second set of beams includes at least one wide beam that is spatially wider than the at least one narrow beam.

According to one or more embodiments of this aspect, the first set of beams includes only narrow beams, and the second set of beams includes only wide beams.

According to one or more embodiments of this aspect, the first set of beams includes at least one wide beam, and the second set of beams includes at least one narrow beam.

According to one or more embodiments of this aspect, the first set of beams includes only wide beams, and the second set of beams includes only narrow beams.

According to one or more embodiments of this aspect, the method includes: causing transmission to the network node of a data collection request; and at least one of: the signal configuration being received based at least on the data collection request; or the measurement report configuration being received based at least on the data collection request.

According to one or more embodiments of this aspect, the data collection request indicates at least one of: the at least one first reference signal resource to be measured; the at least one second reference signal resource to be predicted; a machine learning, ML, model processing capability; a prediction capability; a limitation on a relationship between a first number of the at least one of first reference signal resources and a second number of the at least one second reference signal resources; at least one network node antenna configuration for data collection; or a request for assistance from the network node for training of the ML model.

According to one or more embodiments of this aspect, the at least one first reference signal resource is associated with a first cell, and the at least one second reference signal resource is associated with a second cell different from the first cell.

According to one or more embodiments of this aspect, the wireless device is configured with a dual connectivity configuration, the first cell being a secondary cell, SCell, of the dual connectivity configuration, the first cell being a special cell, sPCell, of the dual connectivity configuration.

According to one or more embodiments of this aspect, the at least one first reference signal resource is associated with a first cell, and the at least one second reference signal resource is associated with the first cell.

According to one or more embodiments of this aspect, the method includes: receiving an indication indicating at least one of a spatial correlation or quasi-co-location, QCL, relation between the at least one first reference signal resource and the at least one second reference signal resource; and the training of the ML model being further based on at least one of the spatial correlation or the QCL relation.

According to one or more embodiments of this aspect, the method includes: causing transmission to the network node of a first indication that the training of the ML model is complete; in response to the first indication, receiving a second indication from the network node indicating that the network node has stopped transmitting at least one of the at least one first reference signal resource or the at least one second reference signal resource; and in response to the second indication, at least one of deactivate and remove at least one of the at least one first reference signal resource or the at least one second reference signal resource.

According to one or more embodiments of this aspect, the method includes: determining that the wireless device has moved from a first location to a second location; and based on the determination, retrain the ML model using at least one additional measurement of the at least one first reference signal resource measured at the second location.

According to one or more embodiments of this aspect, the at least one first reference signal resource includes at least one of: a synchronization signal block, SSB, resource; a channel state information reference signal, CSI-RS, resource; a cell-specific reference signal, CRS, resource; a discovery reference signal, DRS, resource; or a demodulation reference signal, DMRS, resource; and the at least one second reference signal resource includes at least one of: an SSB resource; a CSI-RS resource; a CRS resource; a DRS resource; or a DMRS resource.

According to one or more embodiments of this aspect, the plurality of reference signal resources includes at least of: a periodic resource having a configured periodicity; an aperiodic resource; or a semi-persistent aperiodic resource having a configured periodicity.

According to one or more embodiments of this aspect, the method includes: performing measurements on the at least one first reference signal resource of the plurality of reference signal resources at least one of: upon the wireless device transitioning to an RCC_CONNECTED state from either of a RRC_IDLE state or RRC_INACTIVE state; or as part of a handover procedure.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram illustrating an example beam management procedure;

FIG. 2 is a schematic diagram illustrating an example scenario of two wireless devices moving along similar paths through space;

FIG. 3 is a schematic diagram of an example network architecture illustrating a communication system connected via an intermediate network to a host computer according to the principles in the present disclosure;

FIG. 4 is a block diagram of a host computer communicating via a network node with a wireless device over an at least partially wireless connection according to some embodiments of the present disclosure;

FIG. 5 is a flowchart illustrating example methods implemented in a communication system including a host computer, a network node and a wireless device for executing a client application at a wireless device according to some embodiments of the present disclosure;

FIG. 6 is a flowchart illustrating example methods implemented in a communication system including a host computer, a network node and a wireless device for receiving user data at a wireless device according to some embodiments of the present disclosure;

FIG. 7 is a flowchart illustrating example methods implemented in a communication system including a host computer, a network node and a wireless device for receiving user data from the wireless device at a host computer according to some embodiments of the present disclosure;

FIG. 8 is a flowchart illustrating example methods implemented in a communication system including a host computer, a network node and a wireless device for receiving user data at a host computer according to some embodiments of the present disclosure;

FIG. 9 is a flowchart of an example process in a network node for data collection for spatial domain beam predictions according to some embodiments of the present disclosure;

FIG. 10 is a flowchart of an example process in a wireless device for data collection for spatial domain beam predictions according to some embodiments of the present disclosure;

FIG. 11 is a flowchart of an example process in a network node according to some embodiments of the present disclosure;

FIG. 12 is a flowchart of an example process in a wireless device according to some embodiments of the present disclosure;

FIG. 13 is a schematic illustrating an example configuration of beam sets for measurement prediction according to some embodiments of the present disclosure;

FIG. 14 a schematic illustrating another example configuration of beam sets for measurement prediction according to some embodiments of the present disclosure;

FIG. 15 is schematic illustrating yet another configuration of example beam sets for measurement prediction according to some embodiments of the present disclosure;

FIG. 16 is a schematic illustrating yet another example configuration of beam sets for measurement prediction according to some embodiments of the present disclosure

FIG. 17 is a timing diagram illustrating beam measurement and prediction according to some embodiments of the present disclosure;

FIG. 18 is a signaling diagram illustrating an example beam measurement and prediction procedure according to some embodiments of the present disclosure;

FIG. 19 is a signaling diagram illustrating another example beam measurement and prediction procedure according to some embodiments of the present disclosure; and

FIG. 20 is a signaling diagram illustrating another example beam measurement and prediction procedure according to some embodiments of the present disclosure.

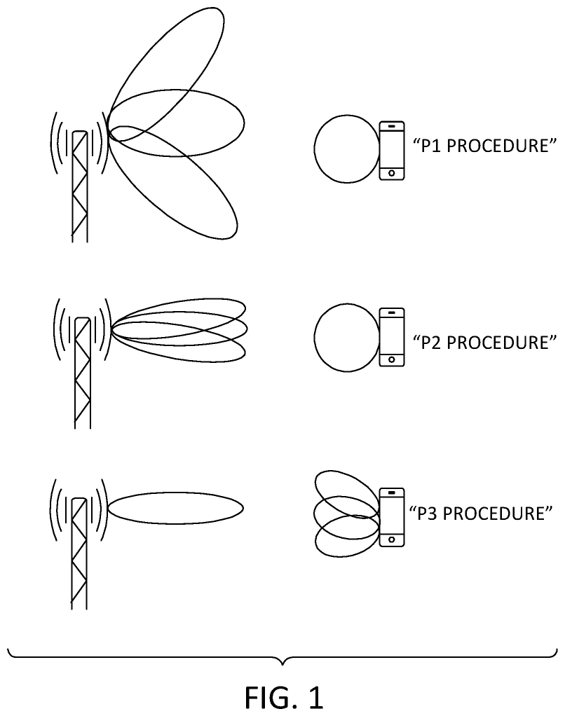

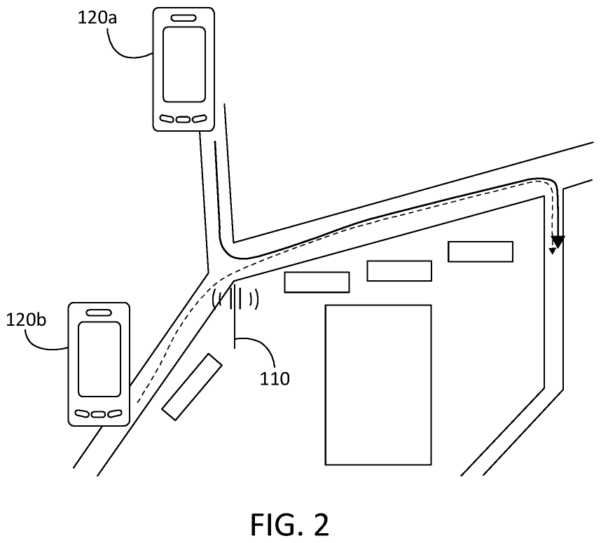

### DETAILED DESCRIPTION

Before describing in detail example embodiments, it is noted that the embodiments reside primarily in combinations of apparatus components and processing steps related to data collection for spatial domain beam predictions. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

The terms “AI/ML model”, “ML-model”, “AI-model”, “Model Inference”, “Model Inference function” are used interchangeably herein. For example, an ML model or Model Inference may be a function that provides AI/ML model inference output (e.g., predictions/estimations/decisions/etc.). The Model Inference function may also be responsible for data preparation (e.g., data pre-processing and cleaning, formatting, and transformation) based on Inference Data delivered by a Data Collection function (which may be a function in the wireless device 22, according to some embodiments of the present disclosure, which receives the CSI measurements used as inputs to train the model). The output may correspond to the inference output of the AI/ML model produced by a Model Inference function.

The term “spatial-domain prediction” in some embodiments may refer to a configuration/method/procedure wherein, based on a Set B of beams, the AI/ML model (e.g., at the wireless device or the network node) may predict another Set A of beams. In some embodiments, for example, predicting the Set A includes the AI/ML model determining/estimating/predicting/etc. a measurement quantity value (e.g., signal metric) for CSI reporting (e.g., RSRP, RSRQ, SINR, RSSI, etc.) of one or more beams, i.e., of one or more DL RSs associated to that beam (e.g., transmitting the same spatial direction and/or with the same spatial properties and/or the same spatial filtering). For example, CSI-RSRP of CSI-RS resource identity X1 is determined without measuring CSI-RSRP of CSI-RS resource identity X1 at that time (or shortly before), but instead, predicting based on a measurement in another beam, e.g., in a different DL RS associated to a different, e.g., SSB index, Y1.

“Training” the AI/ML model in some embodiments of the present disclosure may include a re-training and/or updating of the AI/ML model, such as where the model has already been previously trained.

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide techniques for data collection for spatial domain beam predictions.

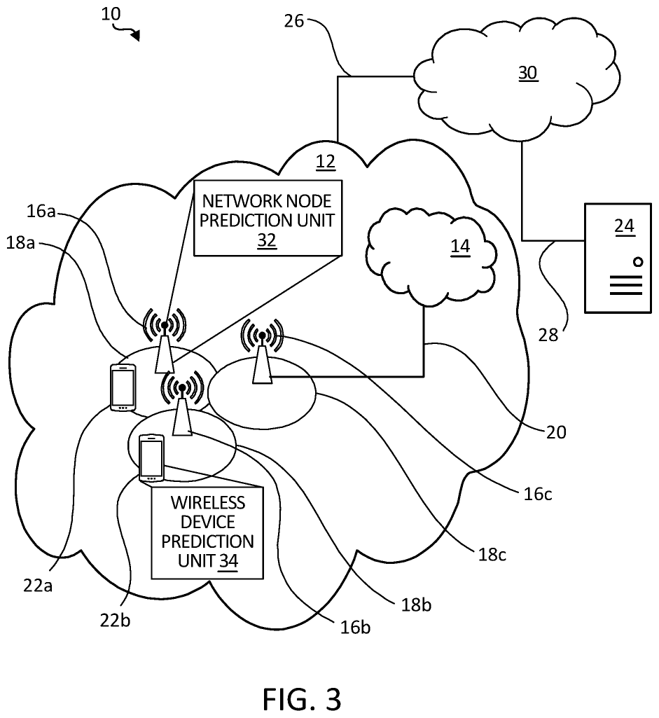

Referring again to the drawing figures, in which like elements are referred to by like reference numerals, there is shown in FIG. 3 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 3 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a network node prediction unit 32 which is configured for data collection for spatial domain beam predictions. A wireless device 22 is configured to include a wireless device prediction unit 34 which is configured for data collection for spatial domain beam predictions.

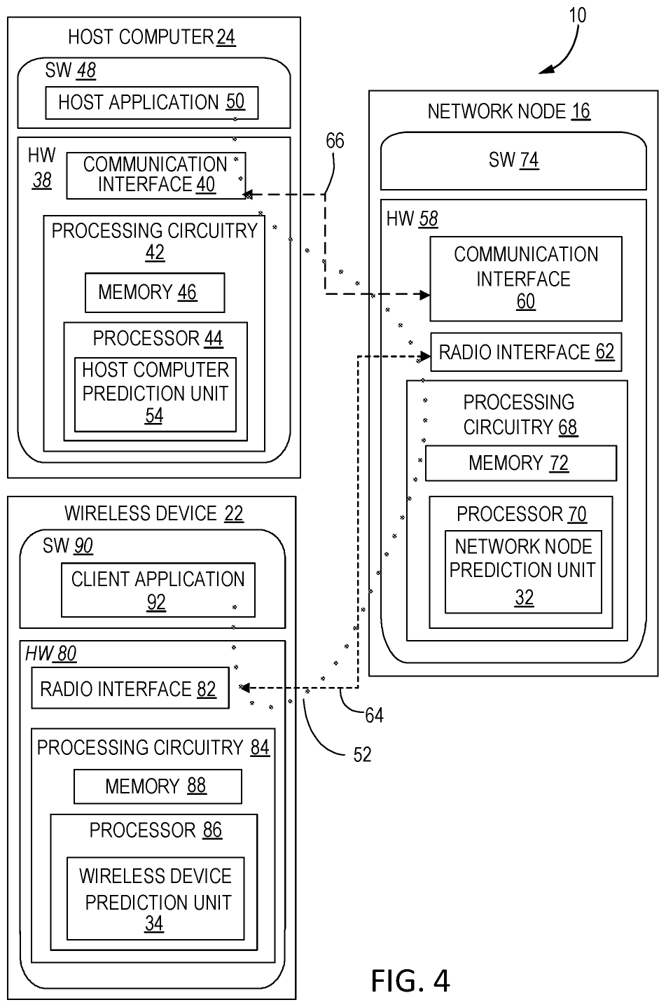

Example implementations, in accordance with an embodiment, of the WD 22, network node 16 and host computer 24 discussed in the preceding paragraphs will now be described with reference to FIG. 4. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22. The processing circuitry 42 of the host computer 24 may include a host computer prediction unit 54 configured to enable the service provider to provide data collection for spatial domain beam predictions, e.g., for/from the network node 16 and/or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. Coverage areas 18 may also be referred to herein as serving cells 18. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include network node prediction unit 32 configured for data collection for spatial domain beam predictions.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a wireless device prediction unit 34 configured for data collection for spatial domain beam predictions.

In some embodiments, the inner workings of the network node 16, WD 22, and host computer 24 may be as shown in FIG. 4 and independently, the surrounding network topology may be that of FIG. 3.

In FIG. 4, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 3 and 4 show various “units” such as network node prediction unit 32 and wireless device prediction unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

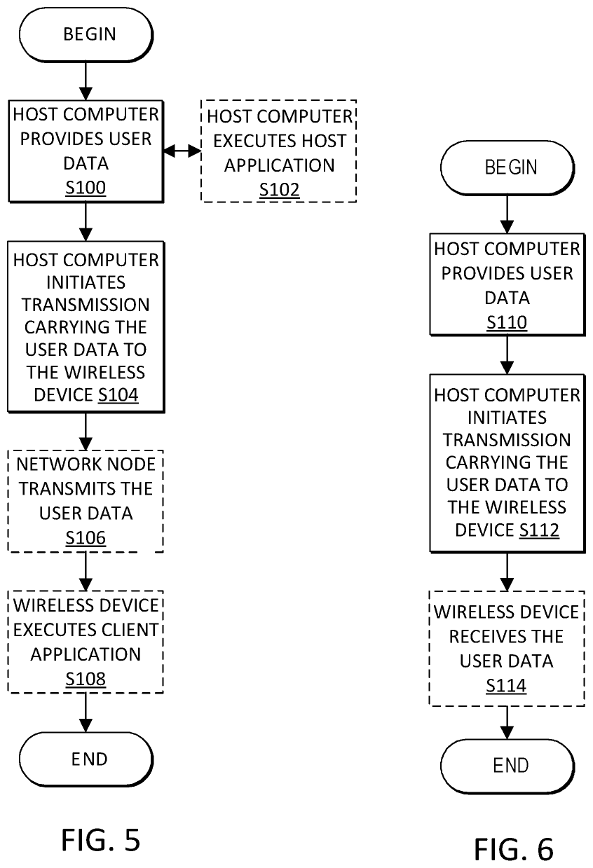

FIG. 5 is a flowchart illustrating an example method implemented in a communication system, such as, for example, the communication system of FIGS. 3 and 4, in accordance with one embodiment. The communication system may include a host computer 24, a network node 16 and a WD 22, which may be those described with reference to FIG. 4. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 6 is a flowchart illustrating an example method implemented in a communication system, such as, for example, the communication system of FIG. 3, in accordance with one embodiment. The communication system may include a host computer 24, a network node 16 and a WD 22, which may be those described with reference to FIGS. 3 and 4. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

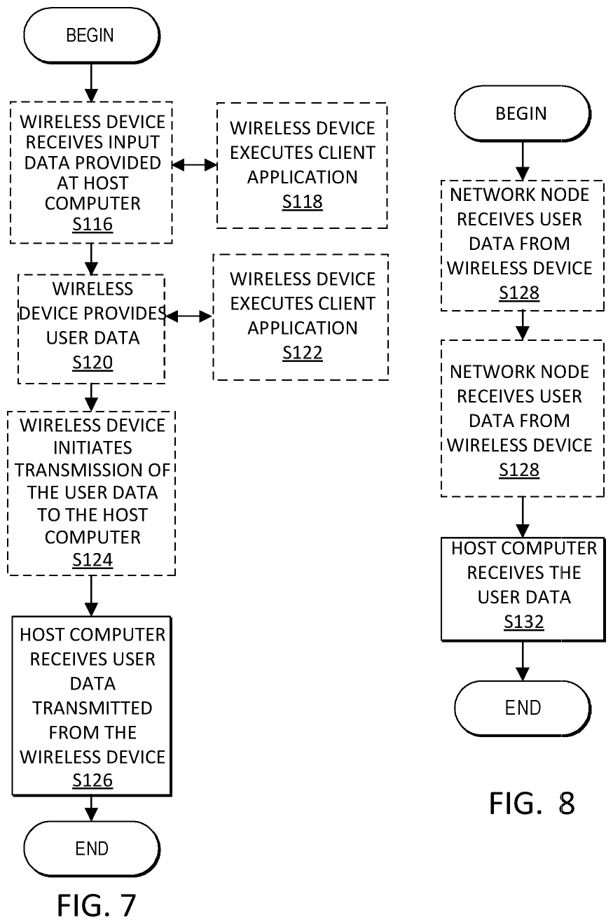

FIG. 7 is a flowchart illustrating an example method implemented in a communication system, such as, for example, the communication system of FIG. 3, in accordance with one embodiment. The communication system may include a host computer 24, a network node 16 and a WD 22, which may be those described with reference to FIGS. 3 and 4. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 8 is a flowchart illustrating an example method implemented in a communication system, such as, for example, the communication system of FIG. 3, in accordance with one embodiment. The communication system may include a host computer 24, a network node 16 and a WD 22, which may be those described with reference to FIGS. 3 and 4. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

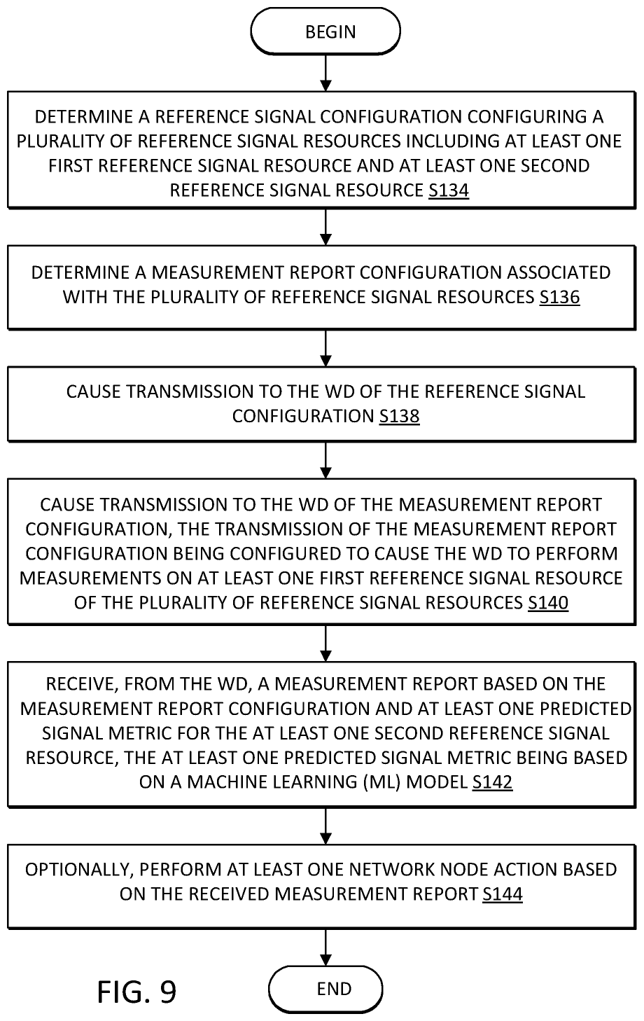

FIG. 9 is a flowchart of an example process in a network node 16 for data collection for spatial domain beam predictions. One or more blocks described herein may be performed by one or more elements of network node 16 such as by one or more of processing circuitry 68 (including the network node prediction unit 32), processor 70, radio interface 62 and/or communication interface 60. Network node 16 is configured to determine (Block S134) a reference signal configuration configuring a plurality of reference signal resources including at least one first reference signal resource and at least one second reference signal resource. Network node 16 is further configured to determine (Block S136) a measurement report configuration associated with the plurality of reference signal resources. Network node 16 is further configured to cause transmission (Block S138) to the wireless device 22 of the reference signal configuration. Network node 16 is further configured to cause transmission (Block S140) to the wireless device 22 of the measurement report configuration, the transmission of the measurement report configuration being configured to cause the wireless device 22 to perform measurements on at least one first reference signal resource of the plurality of reference signal resources. Network node 16 is further configured to receive (Block S142), from the wireless device 22, a measurement report based on the measurement report configuration and at least one predicted signal metric for the at least one second reference signal resource, where the at least one predicted signal metric is based on a machine learning (ML) model. Network node 16 is further configured to, optionally, perform (Block S144) at least one network node action based on the received measurement report.

In some embodiments, the at least one first reference signal resource is associated with a first spatial direction, and the at least one second reference signal resource is associated with a second spatial direction different from the first spatial direction. In some embodiments, the at least one first reference signal resource is associated with a first set of beams, and the at least one second reference signal resource is associated with a second set of beams different from the first set of beams. In some embodiments, the first set of beams includes at least one narrow beam, and the second set of beams includes at least one wide beam. In some embodiments, the first set of beams includes only narrow beams, where the second set of beams includes only wide beams. In some embodiments, the first set of beams includes at least one wide beam, and the second set of beams includes at least one narrow beam. In some embodiments, the first set of beams includes only wide beams, and the second set of beams includes only narrow beams. In some embodiments, the network node 16 is further configured to receive, from the wireless device 22, a prediction request. The determining of the reference signal configuration is based at least on the prediction request and/or the determining of the measurement report configuration is based at least on the prediction request. In some embodiments, the prediction request indicates at least one of the at least one first reference signal resource to be measured, the at least one second reference signal resource to be predicted, a ML model processing capability, a prediction capability, a limitation on a relationship between a first number of the at least one of first reference signal resources and a second number of the at least one second reference signal resources, at least one network node antenna for training and/or measuring, and a request for assistance from the network node for the training of the ML model.

In some embodiments, the at least one first reference signal resource is associated with a first cell 18, and the at least one second reference signal resource is associated with a second cell different from the first cell 18. In some embodiments, the wireless device 22 is configured with a dual connectivity configuration, the first cell 18 is a secondary cell of the dual connectivity configuration, and the second cell 18 is a primary cell of the dual connectivity configuration. In some embodiments, the network node 16 is further configured to cause transmission, to the wireless device 22, of an indication indicating a spatial correlation and/or quasi-co-location (QCL) relation between the at least one first reference signal resource and the at least one second reference signal resource. The training of the ML model is further based on the spatial correlation and/or the QCL relation. In some embodiments, the network node 16 is further configured to receive, from the wireless device 22, a first indication that the training of the ML model is complete. In response to the first indication, the network node 16 is configured to stop transmission of at least one of the at least one first reference signal resource and the at least one second reference signal resource. The network node 16 is further configured to cause transmission of a second indication to the wireless device 22 indicating the stopping, the second indication being configured to cause the wireless device 22 to deactivate and/or remove the at least one first reference signal resource and/or the at least one second reference signal resource.

In some embodiments, the network node is further configured to determine that the wireless device 22 has moved from a first location to a second location, and, based on the determination, cause transmission of an indication to the wireless device 22 to retrain the ML model using at least one additional measurement of the at least one first reference signal resource measured at the second location. In some embodiments, the at least one first reference signal resource includes at least one of a synchronization signal block (SSB), a channel state information reference signal (CSI-RS), a cell-specific reference signal (CRS), a discovery reference signal (DRS), and a demodulation reference signal (DMRS), and the at least one second reference signal resource includes at least one of an SSB, a CSI-RS, a CRS, a DRS, and a DMRS.

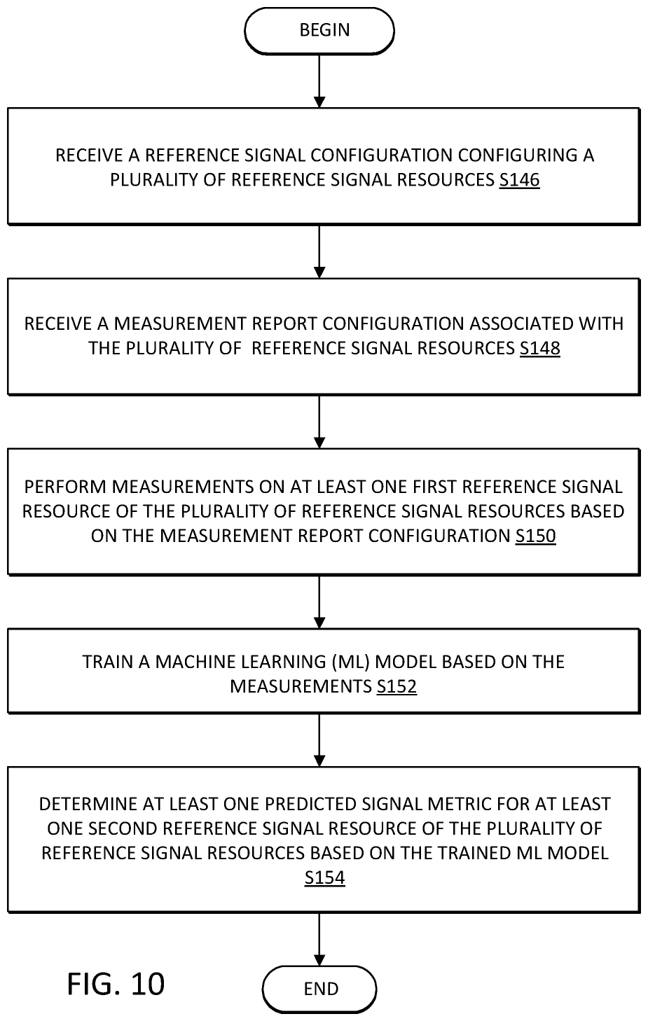

FIG. 10 is a flowchart of an example process in a wireless device 22 according to some embodiments of the present disclosure for data collection for spatial domain beam predictions. One or more blocks described herein may be performed by one or more elements of wireless device 22 such as by one or more of processing circuitry 84 (including the wireless device prediction unit 34), processor 86, radio interface 82 and/or communication interface 60. Wireless device 22 is configured to receive (Block S146) a reference signal configuration configuring a plurality of reference signal resources. Wireless device 22 is configured to receive (Block S148) a measurement report configuration associated with the plurality of reference signal resources. Wireless device 22 is configured to perform measurements (Block S150) on at least one first reference signal resource of the plurality of reference signal resources based on the measurement report configuration. Wireless device 22 is configured to train (Block S152) a machine learning (ML) model based on the measurements. Wireless device 22 is configured to determine (Block S154) at least one predicted signal metric for at least one second reference signal resource of the plurality of reference signal resources based on the trained ML model.

In some embodiments, wireless device 22 is further configured to determine a measurement report based on the measurement report configuration and the at least one predicted signal metric for the at least one second reference signal resource and to transmit the measurement report to the network node.

In some embodiments, the at least one first reference signal resource is associated with a first spatial direction, and the at least one second reference signal resource is associated with a second spatial direction different from the first spatial direction. In some embodiments, the at least one first reference signal resource is associated with a first set of beams, and the at least one second reference signal resource is associated with a second set of beams different from the first set of beams.

In some embodiments, the first set of beams includes at least one narrow beam, and the second set of beams includes at least one wide beam. In some embodiments, the first set of beams includes only narrow beams, and the second set of beams includes only wide beams. In some embodiments, the first set of beams includes at least one wide beam, and the second set of beams includes at least one narrow beam. In some embodiments, the first set of beams includes only wide beams, and the second set of beams includes only narrow beams.

In some embodiments, the wireless device 22 is configured to cause transmission to the network node of a prediction request. The receiving of the reference signal configuration is based at least on the prediction request, and/or the receiving of the measurement report configuration is based at least on the prediction request.

In some embodiments, the prediction request indicates at least one of the at least one first reference signal resource to be measured, the at least one second reference signal resource to be predicted, a ML model processing capability, a prediction capability, a limitation on a relationship between a first number of the at least one of first reference signal resources and a second number of the at least one second reference signal resources, at least one network node 16 antenna for training and/or measuring, and a request for assistance from the network node 16 for the training of the ML model.

In some embodiments, the at least one first reference signal resource is associated with a first cell 18, and the at least one second reference signal resource is associated with a second cell 18 different from the first cell 18. In some embodiments, the wireless device 22 is configured with a dual connectivity configuration, the first cell 18 is a secondary cell of the dual connectivity configuration, and the second cell 18 is a primary cell of the dual connectivity configuration.

In some embodiments, the wireless device 22 is further configured to receive an indication indicating a spatial correlation and/or quasi-Do-location (QCL) relation between the at least one first reference signal resource and the at least one second reference signal resource. The training of the ML model is further based on the spatial correlation and/or the QCL relation.

In some embodiments, the wireless device 22 is further configured to cause transmission to the network node 16 of a first indication that the training of the ML model is complete. In response to the first indication, the wireless device 22 is configured to receive a second indication from the network node 16 indicating that the network node has stopped transmitting at least one of the at least one first reference signal resource and the at least one second reference signal resource. In response to the second indication, the wireless device 22 is configured to deactivate and/or remove the at least one first reference signal resource and/or the at least one second reference signal resource.

In some embodiments, the wireless device 22 is further configured to determine that the wireless device has moved from a first location to a second location, and, based on the determination, retrain the ML model using at least one additional measurement of the at least one first reference signal resource measured at the second location.

In some embodiments, the at least one first reference signal resource includes at least one of a synchronization signal block (SSB), a channel state information reference signal (CSI-RS), a cell-specific reference signal (CRS), a discovery reference signal (DRS), and a demodulation reference signal (DMRS), and the at least one second reference signal resource includes at least one of an SSB, a CSI-RS, a CRS, a DRS, and a DMRS.

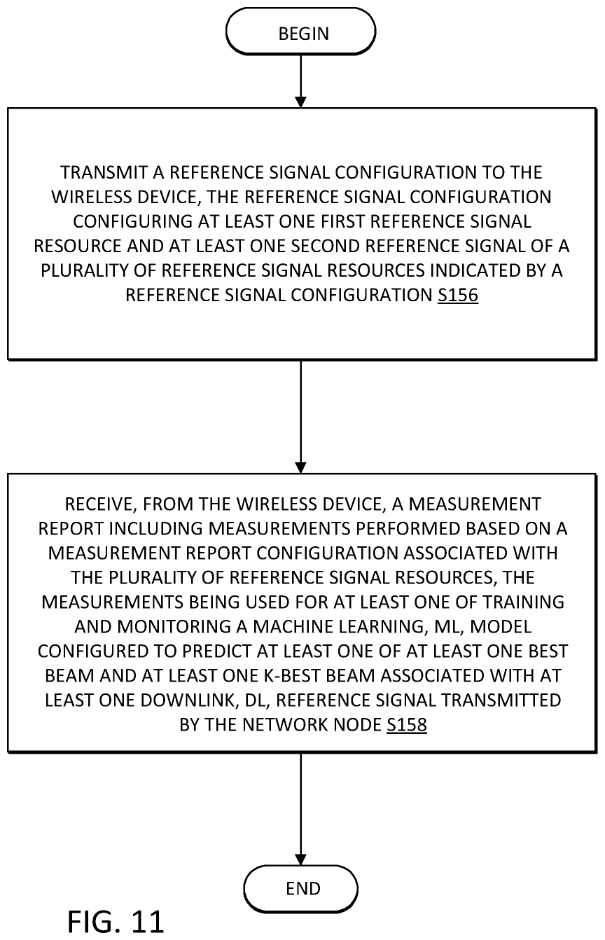

FIG. 11 is a flowchart of an example process in a network node 16 for data collection for spatial domain beam predictions. One or more blocks described herein may be performed by one or more elements of network node 16 such as by one or more of processing circuitry 68 (including the network node prediction unit 32), processor 70, radio interface 62 and/or communication interface 60. Network node 16 is configured to transmit (Block S156) a reference signal configuration to the wireless device 22, the reference signal configuration configuring at least one first reference signal resource and at least one second reference signal of a plurality of reference signal resources indicated by a reference signal configuration. Network node 16 is configured to receive (Block S158), from the wireless device 22, a measurement report including measurements performed based on a measurement report configuration associated with the plurality of reference signal resources, the measurements being used for at least one of training and monitoring a machine learning, ML, model configured to predict at least one of at least one best beam and at least one K-best beam associated with at least one downlink, DL, reference signal transmitted by the network node 16.

In at least one embodiment, the network node is further configured to: configure the wireless device 22 to determine not to transmit a measurement report to the network node 16 based on the measurement report configuration.

In at least one embodiment, the measurement report is based on the measurement report configuration at least one predicted signal metric for the at least one second reference signal resource.

In at least one embodiment, the at least one first reference signal resource is associated with a first spatial direction, and the at least one second reference signal resource is associated with a second spatial direction different from the first spatial direction.

In at least one embodiment, the at least one first reference signal resource belongs to a first reference signal resource set, which is associated with a first set of beams, and the at least one second reference signal resource belongs to a second reference signal resource set, which is associated with a second set of beams different from the first set of beams.

In at least one embodiment, the measurement report contains one of the best Y reference signal or the best Y reference signals with the highest RSRP values from the first reference signal resource set, the second reference signal resource set, or both.

In at least one embodiment, the first set of beams includes at least one narrow beam, and the second set of beams includes at least one wide beam that is spatially wider than the at least one narrow beam.

In at least one embodiment, the first set of beams includes only narrow beams, and the second set of beams includes only wide beams.

In at least one embodiment, the first set of beams includes at least one wide beam, and the second set of beams includes at least one narrow beam.

In at least one embodiment, the first set of beams includes only wide beams, and the second set of beams includes only narrow beams.

In at least one embodiment, network node 16 is further configured to: receive a data collection request; and at least one of: the signal configuration being received based at least on the data collection request; or the measurement report configuration being received based at least on the data collection request.

In at least one embodiment, the data collection request indicates at least one of: the at least one first reference signal resource to be measured; the at least one second reference signal resource to be predicted; a machine learning, ML, model processing capability; a prediction capability; a limitation on a relationship between a first number of the at least one of first reference signal resources and a second number of the at least one second reference signal resources; at least one network node 16 antenna configuration for data collection; or a request for assistance from the network node 16 for training of the ML model.

In at least one embodiment, the at least one first reference signal resource is associated with a first cell, and the at least one second reference signal resource is associated with a second cell different from the first cell.

In at least one embodiment, the wireless device 22 is configured with a dual connectivity configuration, the first cell being a secondary cell, SCell, of the dual connectivity configuration, the first cell being a special cell, sPCell, of the dual connectivity configuration.

In at least one embodiment, the at least one first reference signal resource is associated with a first cell, and the at least one second reference signal resource is associated with the first cell.

In at least one embodiment, network node 16 is further configured to: transmit, to the wireless device 22, an indication indicating at least one of a spatial correlation or quasi-co-location, QCL, relation between the at least one first reference signal resource and the at least one second reference signal resource; and the training of the ML model being further based on at least one of the spatial correlation or the QCL relation.

In at least one embodiment, network node is further configured to: receive a first indication that the training of the ML model is complete; in response to the first indication, transmit a second indication to the wireless device 22 indicating that the network node 16 has stopped transmitting at least one of the at least one first reference signal resource or the at least one second reference signal resource; and the second indication being configured to cause the wireless device 22 to at least one of deactivate and remove at least one of the at least one first reference signal resource or the at least one second reference signal resource.

In at least one embodiment, network node 16 is further configured to: determine that the wireless device 22 has moved from a first location to a second location; and based on the determination, retrain the ML model using at least one additional measurement of the at least one first reference signal resource measured at the second location.

In at least one embodiment, the at least one first reference signal resource includes at least one of: a synchronization signal block, SSB, resource; a channel state information reference signal, CSI-RS, resource; a cell-specific reference signal, CRS, resource; a discovery reference signal, DRS, resource; or a demodulation reference signal, DMRS, resource; and the at least one second reference signal resource includes at least one of: an SSB resource; a CSI-RS resource; a CRS resource; a DRS resource; or a DMRS resource.

In at least one embodiment, the plurality of reference signal resources includes at least of: a periodic resource having a configured periodicity; an aperiodic resource; or a semi-persistent aperiodic resource having a configured periodicity.

In at least one embodiment, network node 16 is further configured to: receive measurements performed on the at least one first reference signal resource of the plurality of reference signal resources at least one of: upon the wireless device 22 transitioning to an RRC_CONNECTED state from either of a RRC_IDLE state or RRC_INACTIVE state; or as part of a handover procedure.

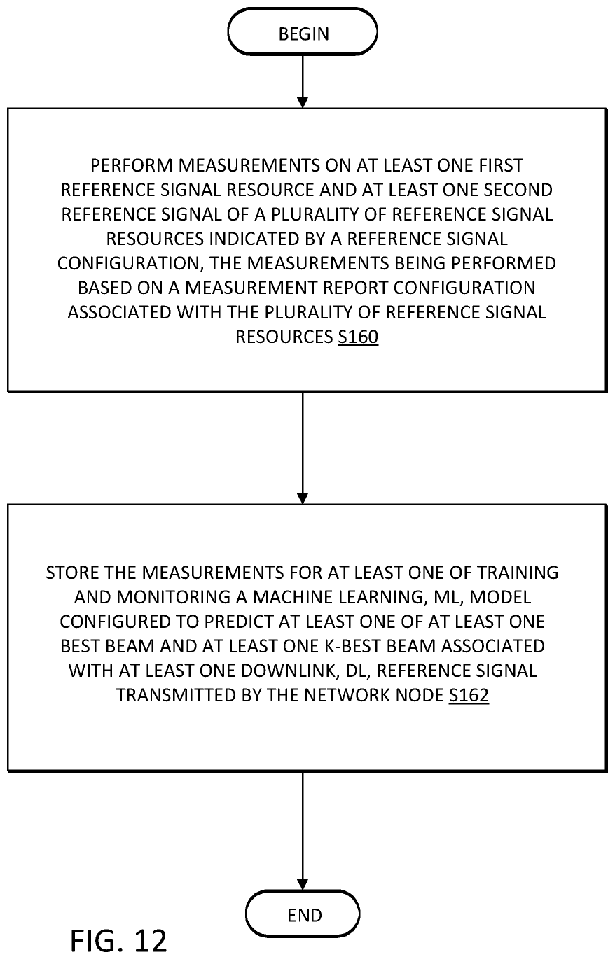

FIG. 12 is a flowchart of an example process in a wireless device 22 according to some embodiments of the present disclosure for data collection for spatial domain beam predictions. One or more blocks described herein may be performed by one or more elements of wireless device 22 such as by one or more of processing circuitry 84 (including the wireless device prediction unit 34), processor 86, radio interface 82 and/or communication interface 60. Wireless device 22 is configured to perform (Block S160) measurements on at least one first reference signal resource and at least one second reference signal of a plurality of reference signal resources indicated by a reference signal configuration, the measurements being performed based on a measurement report configuration associated with the plurality of reference signal resources. Wireless device is configured to store (S162) the measurements for at least one of training and monitoring a machine learning, ML, model configured to predict at least one of at least one best beam and at least one K-best beam associated with at least one downlink, DL, reference signal transmitted by the network node 16.

In at least one embodiment, wireless device 22 is further configured to:
determine not to transmit a measurement report to the network node 16 based on the measurement report configuration.

In at least one embodiment, wireless device 22 is further configured to: determine a measurement report based on the measurement report configuration and at least one predicted signal metric for the at least one second reference signal resource; and transmit the measurement report to the network node 16.

In at least one embodiment, the at least one first reference signal resource is associated with a first spatial direction, and the at least one second reference signal resource is associated with a second spatial direction different from the first spatial direction.

In at least one embodiment, the at least one first reference signal resource belongs to a first reference signal resource set, which is associated with a first set of beams, and the at least one second reference signal resource belongs to a second reference signal resource set, which is associated with a second set of beams different from the first set of beams.

In at least one embodiment, the measurement report contains one of the best Y reference signal or the best Y reference signals with the highest RSRP values from the first reference signal resource set, the second reference signal resource set, or both.

In at least one embodiment, the first set of beams includes at least one narrow beam, and the second set of beams includes at least one wide beam that is spatially wider than the at least one narrow beam.

In at least one embodiment, the first set of beams includes only narrow beams, and the second set of beams includes only wide beams.

In at least one embodiment, the first set of beams includes at least one wide beam, and the second set of beams includes at least one narrow beam.

In at least one embodiment, the first set of beams includes only wide beams, and the second set of beams includes only narrow beams.

In at least one embodiment, wireless device 22 is further configured to: cause transmission to the network node 16 of a data collection request; and at least one of: the signal configuration being received based at least on the data collection request; or the measurement report configuration being received based at least on the data collection request.

In at least one embodiment, the data collection request indicates at least one of: the at least one first reference signal resource to be measured; the at least one second reference signal resource to be predicted; a machine learning, ML, model processing capability; a prediction capability; a limitation on a relationship between a first number of the at least one of first reference signal resources and a second number of the at least one second reference signal resources; at least one network node 16 antenna configuration for data collection; or a request for assistance from the network node 16 for training of the ML model.

In at least one embodiment, the at least one first reference signal resource is associated with a first cell, and the at least one second reference signal resource is associated with a second cell different from the first cell.

In at least one embodiment, the wireless device 22 is configured with a dual connectivity configuration, the first cell being a secondary cell, SCell, of the dual connectivity configuration, the first cell being a special cell, sPCell, of the dual connectivity configuration.

In at least one embodiment, the at least one first reference signal resource is associated with a first cell, and the at least one second reference signal resource is associated with the first cell.

In at least one embodiment, the wireless device is further configured to: receive an indication indicating at least one of a spatial correlation or quasi-co-location, QCL, relation between the at least one first reference signal resource and the at least one second reference signal resource; and the training of the ML model being further based on at least one of the spatial correlation or the QCL relation.

In at least one embodiment, the wireless device is further configured to: cause transmission to the network node 16 of a first indication that the training of the ML model is complete; in response to the first indication, receive a second indication from the network node 16 indicating that the network node 16 has stopped transmitting at least one of the at least one first reference signal resource or the at least one second reference signal resource; and in response to the second indication, at least one of deactivate and remove at least one of the at least one first reference signal resource or the at least one second reference signal resource.

In at least one embodiment, the wireless device is further configured to: determine that the wireless device 22 has moved from a first location to a second location; and based on the determination, retrain the ML model using at least one additional measurement of the at least one first reference signal resource measured at the second location.

In at least one embodiment, the at least one first reference signal resource includes at least one of: a synchronization signal block, SSB, resource; a channel state information reference signal, CSI-RS, resource; a cell-specific reference signal, CRS, resource; a discovery reference signal, DRS, resource; or a demodulation reference signal, DMRS, resource; and the at least one second reference signal resource includes at least one of: an SSB resource; a CSI-RS resource; a CRS resource; a DRS resource; or a DMRS resource.

In at least one embodiment, the plurality of reference signal resources includes at least of: a periodic resource having a configured periodicity; an aperiodic resource; or a semi-persistent aperiodic resource having a configured periodicity.

In at least one embodiment, the wireless device is further configured to: perform measurements on the at least one first reference signal resource of the plurality of reference signal resources at least one of: upon the wireless device 22 transitioning to an RCC_CONNECTED state from either of a RCC_IDLE state or RRC_INACTIVE state; or as part of a handover procedure

Having described the general process flow of arrangements of the disclosure and having provided examples of hardware and software arrangements for implementing the processes and functions of the disclosure, the sections below provide details and examples of arrangements for data collection for spatial domain beam predictions.

According to some embodiments of the present disclosure, an AI/ML model for spatial domain beam prediction may be a functionality or part of a functionality that is related to spatial domain beam prediction and is deployed/implemented/configured/defined/processed/etc. in either the wireless device 22 side and/or the network node 16 side (and/or the host computer 24 and/or core network 14). Although this disclosure discusses several examples of spatial beam prediction, it should be noted that embodiments of the present disclosure may support joint spatial and temporal domain prediction, and hence spatial domain beam prediction may further also include temporal domain prediction in one or more embodiments of the present disclosure.

Further, an AI/ML model for spatial domain beam prediction may be defined as a feature or part of a feature that is related to spatial domain beam prediction and is implemented/supported in a wireless device 22. This wireless device 22 may indicate the feature version to another node, e.g., a network node 16. If the AI/ML model is updated, the feature version may be changed by the wireless device 22. The AI/ML model can be implemented using one or more AI/ML modeling techniques, e.g., linear or nonlinear regression, neural networks (e.g., feedforward, recurrent, convolutional, etc.), decision tree, decision forest, etc.

An ML-model for spatial domain beam prediction may correspond to a function which receives one or more inputs (e.g., channel measurements on a Set B of beams) and may provide as output one or more decision(s), estimation(s), and/or prediction(s) of a certain type (e.g., CSI for one or more of a Set A of beams, and/or top-K predicted beams from Set A of beams or K beams whose associated DL RSs have the K strongest predicted RSRP values from Set A of beams).

In some embodiments of the present disclosure, the predictions may include spatial-domain predictions. Thus, the input of the ML-model may correspond to one or more measurements at (or starting at) a time instance t0 (or a measurement period t0+T) for at least one beam (e.g., SSB identified by SSB index X), e.g., SS-RSRP of SSB index X, which may come from a Set B of beams, and the output of the ML-model includes one or more spatial-domain predicted measurements for that time instance t0 (or that measurement period t0+T) for at least one beam (e.g., SSB identified by SSB index Y), e.g., predicted SS-RSRP of SSB index Y (for that measurement period), for a Set A of beams. The input to the ML-model may include one or more measurements, and may optionally include other types of input to the ML-model, such as positioning, GPS position, etc. An “actor”, as used herein, may refer to a function that receives the output from the Model inference function and triggers or performs corresponding actions. The actor may trigger actions directed to other entities or to itself.

In one example according to some embodiments of the present disclosure, an AI/ML-model may correspond to a function receiving as input one or more measurements of at least one DL RS at time instance t0 (or a time interval starting or ending at t0, such as measurement period t0+T), associated to an RS identifier or index (possibly transmitted in a beam, spatial direction and/or with a spatial direction filter), e.g., transmitted in beam-X, SSB-x, CSI-RS resource index x; and provide as output a prediction of a measurement(s) of a different RS associated to a different RS index (possibly transmitted in a different beam, a different spatial direction and/or with a different spatial direction filter), e.g., transmitted in beam-Y, SSB-y, CSI-RS resource index y. That AI/ML-model may require data collection and training, according to embodiments of the present disclosure.

In some embodiments of the present disclosure, CSI measurements on one or more beams may correspond to measurement of one or more measurement quantities, e.g., RSRP and/or RSRQ, and/or RSSI, and/or SINR, measured on one or more RS(s), e.g., SSB, CSI-RS, Cell-specific Reference Signal (CRS), Discovery Reference Signal (DRS), Demodulation Reference Signal (DMRS), wherein the one or more measured RS(s) may be transmitted in different spatial direction(s), which may be referred as different beams. For example, a measurement on a beam may correspond to a SS-RSRP (Synchronization Signal Reference Signal Received Power) on an SSB index X of a cell Z, wherein the SSB of SSB index X is transmitted in beam/spatial direction. Other examples of measurements include SS-RSRQ, SS-SINR, CSI-RSRP, CSI-RSRQ, and CSI-SINR. Measurements and spatial-domain prediction of measurements on one or more beams may be obtained during a measurement period. For example, a spatial-domain measurement prediction at time t0 may refer to a measurement period which has ended at time t0, e.g., the end of a time window, moving average of measurement samples, etc.

In some embodiments of the present disclosure, methods, systems, and apparatuses are provided data collection for (offline) AI/ML model training for DL spatial domain beam predictions, i.e., for predicting the best or top-K best gNB beams from a Set A of network node 16 (e.g., gNB) beams based on CSI measurements of a Set B of network node 16 beams, wherein the Set A and Set B may be different. Embodiments of the present disclosure provide procedures for DL-RS resource configurations for CSI measurements collection, indication of assistance information from network node 16 to the wireless device 22 for wireless device 22—sided ML model training, triggering events for data collection, and/or the wireless device 22 capability reporting for collecting data for spatial beam prediction.

### Determining a Best Predicted Beam

In a first example, the best predicted beam corresponds to the beam whose associated DL RS (e.g., SSB of SSB index X) has the strongest predicted SS-RSRP (and/or SS-RSRQ, SS-SINR, etc.). In a second example, the best predicted beam corresponds to the beam whose associated DL RS (e.g., CSI-RS of CSI-RS resource identity Y) has the weakest predicted CSI-RSRP (and/or CSI-RSRQ, CSI-SINR, etc.), which may be useful in case the wireless device 22 needs to identity beams which will not be very useful.

The predictor might include a two-step approach, where the first step is predicting the RSRP/SINR of all potential beams in set A, next the second step is selecting/filtering which beam to base the K “best” reference signals in set A. The second step could include selecting the K beams with highest RSRP, or the beams with a predicted RSRP over a certain threshold, or beams where the uncertainty of the prediction is lower than a certain threshold. The first step could in another embodiment include predicting the probability for a beam to be the strongest beam, and the second step includes selecting a number of beams of which there is a sum probability of including the strongest beam in set K.

### DL Spatial Beam Prediction Use Cases

Embodiments of the present disclosure may be applicable to various different DL spatial beam prediction use cases, which may depend on how Set A and Set B are configured for AI/ML model training and inference.

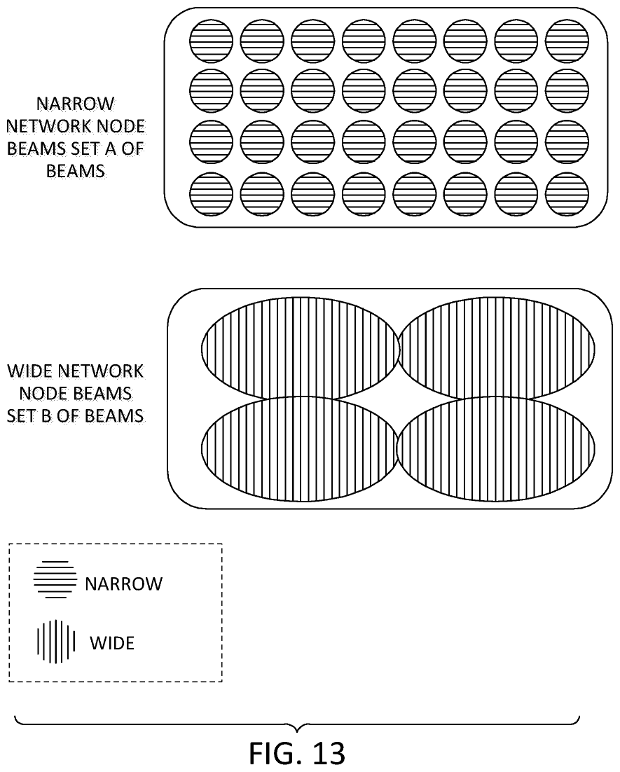

FIG. 13 illustrates an example of DL spatial beam prediction use case, where the top illustration shows all the narrow network node 16 (e.g., gNB) beams, which constitutes the Set A of beams, and the lower illustrations shows all the wide network node 16 beams, which constitutes the Set B of beams. In the example of FIG. 13, the Set B of beams are wide network node 16 (e.g., gNB) beams and the Set A of beams are the narrow network node 16 beams.

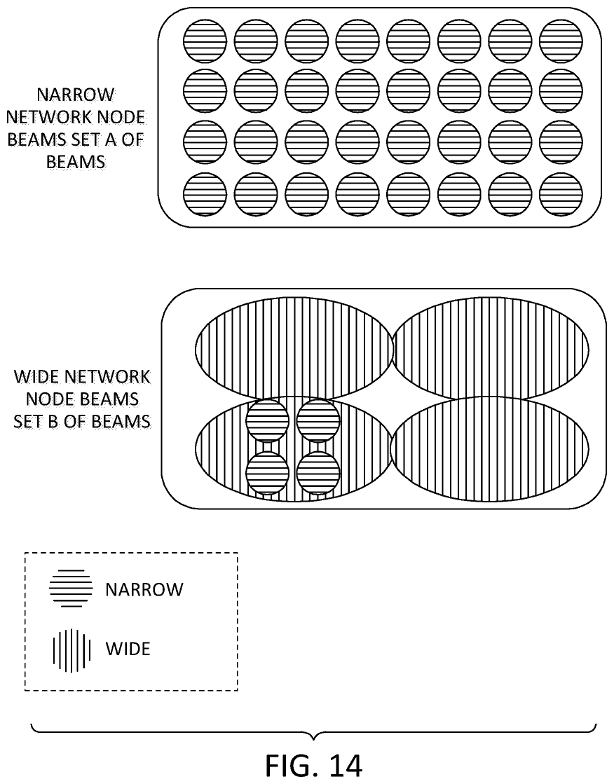

FIG. 14 illustrates another example of DL spatial beam prediction use case, wherein Set A contains narrow network node 16 (e.g., gNB) beams and Set B contains a mix of narrow and wide beams from the network node 16.

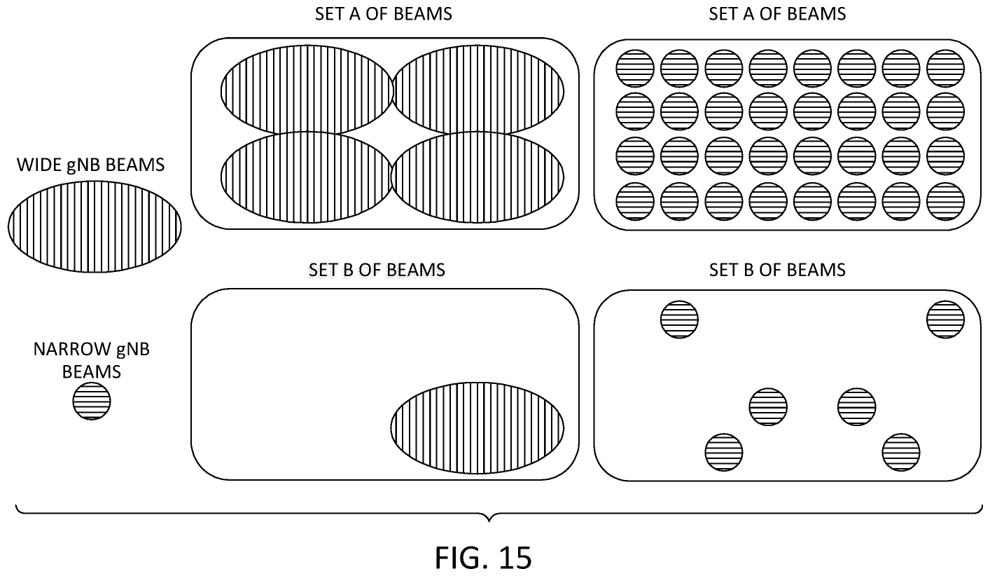

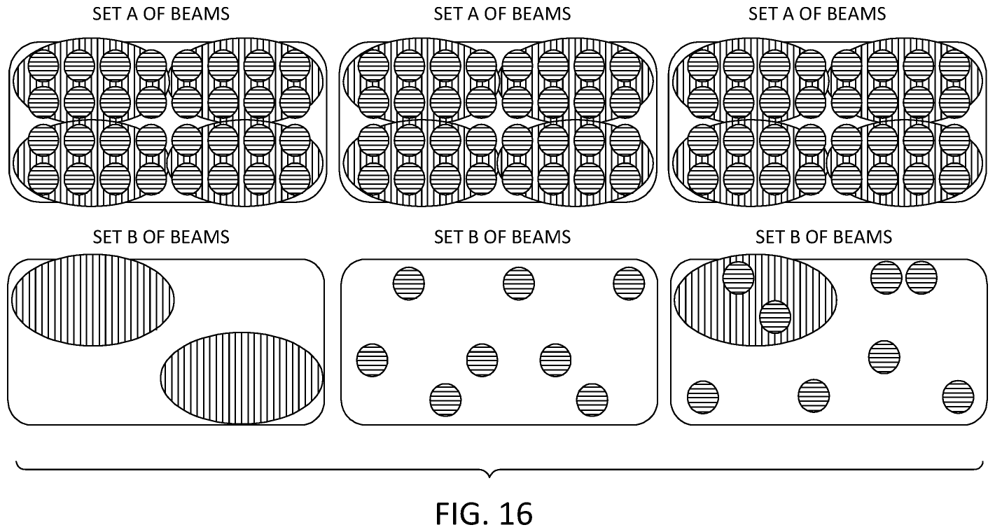

FIG. 15 and FIG. 16 illustrate some other examples of the Set A of beams and the Set B of beams, e.g., where Set B is a subset of Set A. In some configurations, for example:
If Set A only contains the network node 16 (e.g., gNB) wide beams, Set B will be part of Set A of network node 16 wide beams.
If Set A only contains the network node 16 narrow beams, Set B will be part of Set A of network node 16 narrow beams.
If Set A contains a mix of narrow and wide beams from the network node 16, Set B will be one of the following:
be part of Set A of network node 16 wide beams;
be part of Set A of network node 16 narrow beams; and
a mix of part of Set A of narrow and wide beams from the network node 16.

As beams may be formed on the network node 16 side, the wireless device 22 may only be able to measure the result of beamforming. For example, the narrow beams may be measured by CSI-RS resources and the wide beams measured by SSB at the wireless device 22 side, which may be referred to as the wireless device's view/perspective of the beams. In some embodiments, there may be various different CSI-RS wherein some of the CSI-RS represent wide beams and some represent narrow beams, e.g., as beam formed as such by the network node 16 (e.g., gNB). These are non-limiting examples, and embodiments of the present disclosure may utilize and/or be applied to other type of reference signals and combinations thereof.

### Data Collection for Various Different Scenarios of AI/ML Model Training (Where AI/ML Model Training Entity/Functionality May be Located at the Wireless Device 22 Side or Network Node 16 Side)

As the DL Tx beams as well as the configuration of Set A and Set B of beams for spatial beam prediction are configured and known by the network node 16, the data collection procedure/configuration may vary depending on whether the model training entity is located at the network node 16 side or the wireless device 22 side.

### Case 1: AI/ML Model is Trained at the Network Node 16 Side

In some embodiments of the present disclosure, for the cases where the AI/ML model is trained at the network node 16 side, to reduce DL-RS transmission overhead at the network node 16, reduce the CSI measurements overhead at the wireless device 22, and shorten the data collection latency, the network node 16 only needs to configure a set of DL-RS resources associated to all beams in the union of Set A and Set B for the wireless device 22 to perform CSI measurements on. For example, if both Set A and Set B consist only narrow CSI-RS beams, and Set B is a subset of Set A, then, only CSI-RS resources associated to the beams in Set A is configured and only Set A of beams is transmitted over these CSI-RS resources for the data collection purposes. The network node 16 may also configure a reporting configuration associated to the DL-RS resource configuration(s) for it to obtain the measurement data from the wireless device 22. However, there is no need for the network node 16 to indicate the Set A and Set B configurations to the wireless device 22 for data collection for (offline) model training, since the wireless device 22 can create training data set(s) from the collected data using the Set A and Set B configuration rule that is designed by itself for the AI/ML model training and inference.

In an embodiment, the network node 16 configures a single set of DL-RS resources for wireless device 22 to perform CSI measurements at one or multiple data collection time instance(s), where the set of DL-RS resources may be associated to the beams in the union of Set A and Set B.

In some embodiments, the union of Set A and Set B may be the Set A. Hence, in some embodiments, the network node 16 may configure and transmit only the Set A of beams over the configured DL-RS resources for data collection.

As shown in FIG. 14, FIG. 15, and FIG. 16, Set A or/and Set B may consist of different types of DL-RSs, e.g., SSB and CSI-RS. Hence, in some embodiments, the configured set of DL-RS resources may include more than one type of DL-RS resources (e.g., SSB and CSI-RS).

### Case 2: AI/ML Model is Trained at the Wireless Device 22 Side

In some embodiments, for the cases where the AI/ML model is trained at the wireless device 22 side, besides the CSI measurements of all beams in the union of Set A and Set B, the model training entity at the wireless device 22 side (e.g., a wireless device 22 or another node like a computer server (e.g., host computer 24) of a wireless device vendor) may request/require additional information from the network node 16 to be able to create proper data sets to train the AI/ML model. The network node 16 may be configured to provide information about Set A and Set B configuration to the wireless device 22. This may be achieved, for example, by indicating the Set A and Set B configuration explicitly in the DL-RS configuration(s) for CSI measurements (e.g., by defining two sets of DL-RS resources and indicating which one is for set A and which one is for set B) or implicitly indicating the rule(s) for creating Set A and Set B (e.g., Set A corresponds to the M DL-RS resources configured in the DL-RS resource configuration(s) for the model training, while Set B consists of N DL-RS resources that are randomly selected from the M DL-RS resources). The network node 16 may also need to indicate whether the beam configuration at the network node 16 has been updated or not (e.g., by indicating a Network Node Antenna Configuration ID), in order for the wireless device 22 to perform correct data labeling. In embodiments where, the AI/ML model is trained at the wireless device 22 side, there may be no need for the wireless device 22 to report the collected data to the network node 16.

In an embodiment, the network node 16 indicates the configuration of Set A and Set B to the wireless device 22 by configuring two sets of DL-RS resources with one DL-RS resource associated to Set A and the other DL-RS resource set associated to Set B.

As shown in FIG. 14, FIG. 15, and FIG. 16, example configurations of Set A or/and Set B may include various different types of DL-RSs, e.g., SSB and CSI-RS. Hence, in some embodiments, at least one of two configured DL-RS resource sets includes more than one type of DL-RS resources (e.g., SSB and CSI-RS).

In another embodiment, the network node 16 may indicate the configuration of Set A and Set B to the wireless device 22 by indicating the rule(s)/parameter(s) for creating Set A and Set B for AI/ML model training and inference. The rule(s)/parameter(s) may include the number of beams in Set A (M), the number of beams in Set B (N), and how Set B is configured (e.g., a random selection of N beams out of M beams in Set A, or top-N strongest SSB beams in the previous measurements within a certain time window, etc.).

In another embodiment, the network node 16 may indicate assistance information such as a Network Node Antenna Configuration ID or similar antenna configuration identifier/indication/control signaling, which indicates one or more particular antenna configuration(s) and/or beam configuration(s) at the network node 16. The training data set may be created using the CSI measurements together with the assistance information provided by the network node 16.

In another embodiment, the network node 16 configures the wireless device 22 to not report the CSI measurements that are configured for data collection, e.g., to enable AI/ML model training at the wireless device 22 side.

### DL RS Resource Configurations, Set A and Set B Configurations, and Assistance Information for Data Collection

In some embodiments, to collect CSI measurements with AI/ML model training, the wireless device 22 may be configured with a DL reference signal configuration within a message. This message may, for example, be an RRCReconfiguration message (or an RRC Resume message, when the wireless device 22 transitions from RRC_INACTIVE) or an MAC CE. The DL reference configuration may contain configurations of two or more reference signals. The reference signals may be, for example, of one or more of the following types: CSI-RS, TRS, PRS or SSB. For the case of SSB, the specific reference signals may be the primary or secondary synchronization signals or any other reference signal included in the SSB configuration. The DL reference configuration may contain two or more sets of reference signals. In case it contains two sets, each set may contain reference signals of one type only or a mix of types (e.g., SSBs and CSRI-RSs). The DL reference configuration may also contain more than two sets of reference signals, for example three or four sets. This configuration may be similar to the example illustrated in FIG. 13, where the first set is denoted by Set B and the second set is denoted by Set A. In the illustration of FIG. 13, Set A contains CSI-RS resources and each CSI-RS is transmitted within a narrow beam from the network node 16; Set B contains SSB resources and each SSB is transmitted within a wide beam from the network node 16. Further, a sub-set of CSI-RS resources may be transmitted within each wide beam. This association between the SSB and CSI-RS resources (in other words, between narrow and wide beams) may be defined and indicated to the wireless device 22 by the network node 16 providing spatial correlation properties and QCL association of CSI-RS towards the SSBs. In some embodiments of the present disclosure, the wireless device 22 does not have to be aware that SSBs are transmitted in wide beams and CSI-RSs are transmitted in narrow beams.

According to one or more embodiments of the present disclosure, the wireless device 22 may be further configured to measure on both Set A and Set B for data collection. However, when an AI/ML model is trained for spatial-domain prediction of one or more beams, e.g., for predicting the best or K-best reference signal(s), the AI/ML model may be trained based on the wireless device 22 measuring reference signals within the Set B and, based thereon, predicting the best or K-best reference signals within the Set A. There may be restrictions on the number of reference signal measurements that are available within Set B when performing the prediction. The actual training may occur within the wireless device 22, a network node 16 (e.g., gNB, RAN or Core network node), and/or or another type of node (e.g., a host computer). The node performing the training may have the measured data and the applicable configuration available, e.g., the Set A and Set B configuration provided by the network node 16 to the wireless device 22 and the actual measurement results the wireless device 22 has measured. Predicting the best beam may include predicting the best beam in terms of L1-RSRP, RSRQ, RSSI, SINR, CQI, rank, and/or similar radio property/quality measurements.

The reference signals in the different Sets A and B may be mutually exclusive in some embodiments, but may also be partly overlapping. For example, Set B may include beams with indexes X1, X2, and X3, while the Set A includes beams with indexes X1, X2, X3, X4, X5, X6, . . . , X64. In this example, despite the overlap, there are fewer beams in Set B compared to Set A, which means the wireless device 22 is required to perform fewer CSI measurements compared to as if the wireless device 22 would have to measure the beam within Set B. However, embodiments of the present disclosure are not limited to this scenario, as even in the case where Set B is not smaller than Set A, the actual measurements performed may differ such that, in some embodiments, it may be more efficient (in terms of power consumption, time, etc.) for the wireless device 22 to measure more beams in the Set B to predict fewer beams in A (e.g., assuming the effort to measure the Set B is smaller and/or assuming Set B is more easily available than the Set A).

In some embodiments of the present disclosure, there may be a relationship/association/mapping between the number of reference signals and their associated properties in each of the Set A and Set B. This may ensure that it is feasible to later train a predictor that can be based on measurement(s) of reference signals from Set B to predict the best or K-best reference signals in Set A. This relationship can be, for example, a relative difference in a number of reference signals in both Set A and Set B. For example, there may, in addition, be a maximum and/or minimum number of reference signals for Set A and/or Set B. For example, there may further be a maximum and/or minimum number in terms of spatial correlations and/or QCL association between of reference signals in Set A to Set B. For example, there may be cases where there is always a need to have a spatial correlation and/or QCL association for a reference signal in Set A to a reference signal in Set B. The spatial correlation may be used to indicate different correlations between different beams in the two different sets (Set A and Set B of beams). For example, the spatial correlation between two beams (e.g., A1 from Set A and B1 from Set B) may indicate how likely it is that when Al is associated with high RSRP, B1 is also associated with high RSRP. In another example, the spatial correlation may indicate how likely it is that when a certain beam from Set B (B1) has the highest RSRP from all Set B of beams, a certain beam from Set A of beams (A1) will have the highest RSRP from all Set A of beams. For each reference signal within Set B, there may be a maximum limit on the number of reference signals within Set A it can have a spatial correlation or/and QCL association with. For example, associating too many narrow beams with a wide beam may lead to an undesirably complex design of an accurate predicator. On the other hand, the minimum number of reference signals to be able to be predicted (e.g., the number of beams in Set A) should be large enough to make it beneficial to have a prediction algorithm (e.g., to achieve sufficient overhead reduction in terms of DL-RS transmission and the associated procedure for that) and hence, the minimum number needs to be sufficiently large.

In some embodiments, the wireless device 22 may be configured with one or more sets of DL RS resources associated to the Set B and the Set A, where the wireless device 22 performs one or more spatial domain predictions for Set A of beams based on the measurements on Set B of beams. The measurements of Set A and Set B of beams may be collected and used to create training data set(s) for training the AI/ML model. The configured DL RS resources for Set A of beams may be transmitted less often than the Set B and/or on demand.

In some embodiments, the Set A of beams and the Set B of beams configured for data collection for AI/ML model training may include sets of beams from different serving cells 18.
In one embodiment, the Set A is a set of beams of an SCell, while the Set B is a set of beams of an SpCell (e.g., PCell in case of a Master Cell Group).
In one embodiment, the Set A is a set of beams of the SpCell (e.g., PCell in case of a Master Cell Group), while the Set B is a set of beams of an SCell.

In some embodiments, the Set A of beams and the Set B of beams configured for data collection for AI/ML model training are sets of beams from the same serving cell 18.
In one embodiment, both the Set A and the Set B are sets of beams of an SCell.
In one embodiment, both the Set A and the Set B are sets of beams of an SpCell (e.g., PCell in case of a Master Cell Group).

In some embodiments, the Set A of beams may include beams from more than one serving cell 18.

In some embodiments, the Set B of beams may include beams from more than one serving cell 18.

In some embodiments, there may be multiple instances of Set A of beams and the Set B (e.g., pair(s) of configurations) of beams configured for data collection for AI/ML model training, where each instance may be associated to one or more of:
a configured serving cell, in which case, if the wireless device 22 is configured with X serving cells, there may be X pairs of Set A and Set B configuration(s), so that the wireless device 22 may be able to train an AI/ML model on a per serving cell basis;
a configured serving frequency, in which case, if the wireless device 22 is configured with X serving frequencies, there may be X pairs of Set A and Set B configuration(s), so that the wireless device 22 may be able to train an AI/ML mode on a per serving frequency basis; and
a frequency range, e.g., FR1 and FR2, in which case, if the wireless device 22 is configured with serving cells/frequencies in a Frequency Range (e.g., FR1), there may be a pair of Set A and Set B configuration(s) for FR1, so that the wireless device 22 may be able to train an AI/ML mode for FR1 beams. Similarly, there may be a pair of Set A and Set B configuration(s) for FR2.

In some embodiments, during the data collection, the network node 16 does not change its beam configuration, e.g., which reference signal is transmitted over what beam and using which set of antennas, and/or which transmission power is used for each respective beam. For example, the network node 16 may indicate the used Tx power for a certain reference signal to enable the wireless device 22 to compensate for this effect. This may aid the training process later by assuming that the network node 16 behavior is constant.

In some embodiments, the wireless device 22 may further receive a configuration message containing a CSI report configuration that may be in the same configuration discussed above or may be in a separate configuration message. The configuration message may, for example, be an RRC Reconfiguration and/or an RRC Resume and/or an RRC Setup and/or MAC CE. That message may contain fields and/or Information Elements (IEs) creating an association/relationship/mapping to DL reference signal configuration(s). The message may indicate which reference signal the wireless device 22 should measure on and for what purpose the wireless device 22 should measure on them. For example, the purpose in the message may be indicated by the report quantity being set to ‘none’ or a value indicating that the purpose is for data collection purposes, e.g., AI/ML model training.

In addition to the above information, the network node 16 may indicate additional assistance information to the wireless device 22. Such information can, for example, include:
Azimuth and elevation pointing angle of different network node 16 Tx beams of Set A and/or Set B of beams;
Beamwidth for different network node 16 Tx beams of Set A and/or Set B of beams; and/or
Network Node Antenna Configuration ID, wherein the antenna configuration ID indicates a number that indicates a certain antenna configuration and/or beam configuration at the network node 16 to associate the training data with.

The Network Node Antenna configuration ID may be used later for the wireless device 22 to be able to know if its train model is done on given network node 16 antenna and/or beam management configuration, e.g., by the wireless device 22 associating the ID to the training data.

### Triggering Events for Initiating/Stopping Data Collection

In some embodiments, after the configuration of the reference signals and any associated measurement reports, if applicable, the network node 16 triggers measurements of the reference signals. This could be done in different manner. The actual reference signals may be periodic, semi-persistently or aperiodically transmitted. The transmitting may be based on the configuration and/or based on which type of reference signal is being transmitted. For example, in some embodiments, the SSB may only be transmitted periodically, while the CSI-RS may be transmitted periodic, semi-persistently or aperiodically. It should be noted that if the reference signals are periodic, the triggering may occur in the same message as the configuration. The wireless device 22 measures the reference signaling and collects the measurements. In addition, there may be a time limit on how long the data collection procedure may occur. This may beneficially reduce/limit usage of network resource for this purpose, and this limit may be provided together with configuration of reference signals and/or the CSI report configuration.

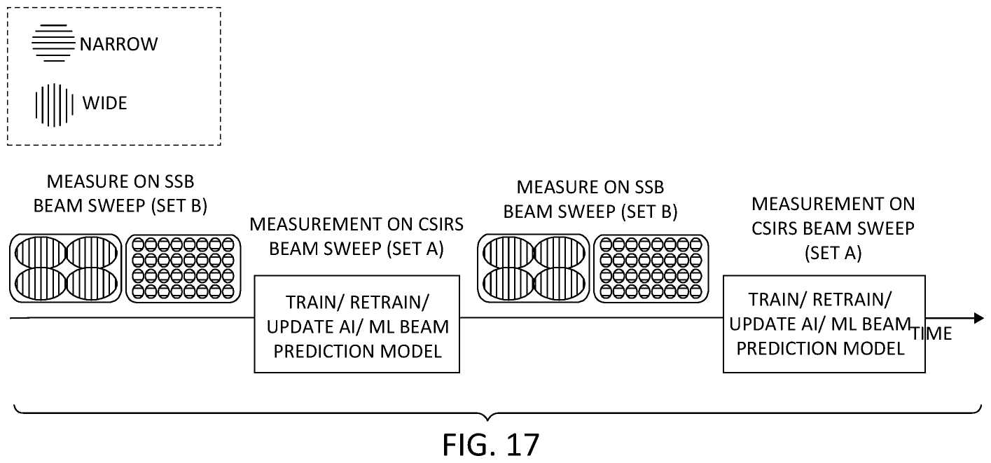

It should be noted that even for the case when the wireless device 22 and/or network node 16 has trained the AI/ML model for beam prediction, it may be beneficial to collect more training data. This could be for the purpose of improving the AI/ML model (e.g., accuracy, speed, etc.) or verifying that it works, as shown in the example timing diagram of FIG. 17.

FIG. 17 illustrates aspects of an example method and configuration according to one or more embodiments of the present disclosure. In this example, the network node 16 (e.g., gNB) transmits a burst of SSB in a Set B of beams and a CSI-RS burst in a Set A of beams. This method can then be iteratively repeated multiple times to improve the AI/ML model prediction (e.g., improve accuracy, speed, etc.) independent of whether it is performed in the wireless device 22 or in another node, such as another wireless device 22, network node 16, core network 14, host computer 24, etc.

In some embodiments, the data collection may be initiated by the wireless device 22 request to be configured with data collection for beam prediction purposes. For example, for wireless device 22 sided beam prediction use cases (e.g., where the AI/ML model is deployed at the wireless device 22 side), the wireless device 22 may not have an AI/ML model, the current AI/ML model may not be trained based on the current “Network Node Antenna configuration ID” provided by the network node 16 for inference, the wireless device 22 may have identified that the beam predictor that the wireless device 22 is using is not functioning well enough (fast enough, accurately enough, etc.), e.g., upon detecting that the performance of the spatial-domain beam prediction is poor or/and below an acceptable level. The request from the wireless device 22 to the network node 16 may be included in an RRC message, e.g., wireless device 22 assistance information (“UE Assistance Information”) or other RRC message. Other example events which may trigger the wireless device 22 to transmit the request for data collection for beam prediction include, for example:
When the wireless device 22 transitions to RRC_CONNECTED in a cell e.g., from RCC_IDLE or RRC_INACTIVE;
In one example, if the wireless device 22 is transitioning from RRC_IDLE, the wireless device 22 includes an indication in the RRC Setup Complete message, to indicate that it needs to be configured by the network node 16 for data collection for training the AI/ML model. In response, the wireless device 22 may receive the configuration in the RRC Reconfiguration, e.g., after security activation;
In another example, if the wireless device 22 is transitioning from RCC_INACTIVE, the wireless device 22 includes an indication in the RRC Resume Complete message, to indicate that it needs to be configured by the network node 16 for data collection for training the AI/ML model. In response, the wireless device 22 may receive the configuration in a subsequent RRC Reconfiguration, e.g., after resume. In another example, the indication may be included in the RRC Resume Request message, to indicate that the wireless device 22 needs to be configured by the network for data collection for training the AI/ML model. In response, the wireless device 22 may receive the configuration in the RRC Resume message;
When the wireless device 22 is attaching to the network; and/or
When the wireless device 22 detects a degradation in the performance of the AI/ML model providing spatial domain predictions.

In some embodiments, when the network node 16 triggers a handover and/or other reconfiguration with sync, data collection may also be triggered. The target network node 16 in a handover preparation configures the wireless device 22 for data collection for AI/ML model training so the wireless device 22 gets prepared to perform spatial domain prediction(s) of beams in the target cell 18 after the reconfiguration with sync.
In one or more embodiments, the source network node 16 indicates to the target network node 16 that the wireless device 22 requires data collection for training the AI/ML model for spatial-domain beam prediction (or indicates that the wireless device 22 is capable of spatial-domain prediction), so that the target network node 16 may include in the RRC Reconfiguration (handover command, as part of the Serving Cell Configuration of the target cell 18) the configuration for the data collection, e.g., the configuration including the sets of DL RSs resources for the wireless device 22 to perform the CSI measurements to train the AI/ML model.
In one or more embodiments, the wireless device 22 includes in an RRC measurements report, such as for a triggered cell 18 (e.g., cell fulfilling the criteria for an A3 event, e.g., RSRP offset better than PCell's RSRP), an indication of its need for data collection for that triggered cell in case the wireless device 22 moves there. That information may be received by the source network node 16, and may be provided to the target network node 16 so that the target network node 16 may configure the wireless device 22 with the data collection for the target cell.

The data collection may also be initiated based on a network node 16 request indicating that the wireless device 22 shall perform the data collection part. It is noted here that the actual beam predictor may not be located within the wireless device 22 but could be in the network node 16, however, in order for the network node 16 to train a beam predictor, the network node 16 training the beam predictor would need measurements from the wireless device 22 or wireless device 22s. Hence, for such a case, the data collection may be initiated by the network node 16, and the wireless device 22 may report the measurements from the Set A and/or Set B to the network. Particularly, for such a case, it may be sufficient for the network to configure the wireless device 22 with a single set of reference signals to measure on, because the network node 16 trains and uses the trained AI/ML model and hence may have information beforehand regarding which possible sets of reference signals would be available for measurement and should be predicted during inference. For example, as long as the wireless device 22 reports all the measured reference signals, the network node 16 may split apart reference signals within the training process and/or create proper training data set(s). In some embodiments, the network node 16 may configure the wireless device 22 to perform one or more measurements for data collection for training an AI/ML model for spatial domain prediction of beams at the occurrence of one of more of the following events:
When the wireless device 22 transitions to RRC_CONNECTED in a cell 18, e.g., from RCC_IDLE or RCC_INACTIVE;

When the network node 16 triggers a handover and/or other reconfiguration with sync; in that case it is the target network node 16 in a handover which configures the wireless device 22 for data collection for AI/ML model training so the wireless device 22 gets prepared to perform spatial domain prediction(s) of beams in the target cell after the reconfiguration with sync;
When the network node 16 detects a wireless device 22 attaching to the network;
When the network node 16 detects that the wireless device 22 is entering a cell 18 (e.g., in a handover) which is not a cell 18 for which the wireless device 22 has a trained AI/ML model for spatial-domain prediction; and/or
When the network node 16 detects a degradation in the performance (e.g., accuracy, speed, etc.) of the AI/ML model providing spatial domain predictions.

In some embodiments, the network node 16 may configure the wireless device 22 to perform one or more measurements for data collection for training an AI/ML model for spatial domain prediction of beams after the network has received a wireless device 22 capability indicating that the wireless device 22 is capable of performing spatial-domain prediction of a set of beams based on CSI measurements of another set of beams. The network node 16 may determine to configure the data collection based on the reported capability.

In some embodiments, the wireless device 22 reports to the network node 16 a wireless device 22 capability related to the capability the wireless device 22 has to perform spatial-domain prediction of a set of beams based on CSI measurements of another set of beams. In response, the wireless device 22 may receive (e.g., from the network node 16) the network configuration for data collection.

In some embodiments, the wireless device 22 indicates to the network node 16 that data collection is over, e.g., when the wireless device 22 finishes the AI/ML model training.
In some embodiments, the wireless device 22 receives from the network node 16 an indication that the network node 16 has stopped transmitting the sets of DL RSs and an indication to deactivate (e.g., MAC CE and/or DCI) and/or to remove the DL RS resource sets at the wireless device 22 (e.g., an RRC Reconfiguration message).

In some embodiments, when the wireless device 22 is configured for data collection according to the method the wireless device 22 starts a timer (Txxx) and while the timer is running the wireless device 22 performs data collection for training, and expects the network to transmit the DL RSs in Set A and Set B. When the timer expires, the wireless device 22 stops data collection, e.g., stops performing measurements on the configured DL RSs in Set A and Set B. The network node 16 also keeps an instance of the timer and upon expiry it stops the transmissions of the DL RSs.

### Wireless Device Capability of Supporting Data Collection for DL Spatial Beam Prediction

In some embodiments, the wireless device 22 may further indicate to the network node 16 the capability to support data collection for beam prediction. The wireless device 22 capabilities may include one or more of the following information:
how many total references signals the wireless device 22 can measure for data collection purposes,
the number of reference signals within Set A and Set B, together with any relationship between them. The relationship and the number could be absolute number but also relative, e.g., in the sense that the Set A can contain X number more/fewer reference signals then Set B;
Network Node Antenna configuration IDs for which the wireless device 22 is interested in collecting data.
In some embodiments, the Network Node Antenna configuration ID indication may also include information on how well trained the AI/ML model is for respective Network Node Antenna configuration ID (for example, how many measurements performed, etc., to train the AI/ML model);
Network Node Antenna Configuration IDs for which the wireless device 22 is not interested in collecting data;
Support of spatial predicted beam report from a Set A of beams based on measurements on a Set B of beams, where the Set B of beams are different compared to the Set A of beams;
Maximum number of beams supported in Set A;
Maximum number of beams supported in Set B;
Minimum number of beams supported in Set A;
Minimum number of beams supported in Set B;
AI/ML model processing capability;
For instance, how much time does it take (or how many measurement occasions) for the wireless device 22 to train/retrain/update its model based on the measurements of the Set A and Set B of beams, which might impact the configuration of DL RS transmission, e.g., the periodicity of transmitting the Set A and set B of beams.

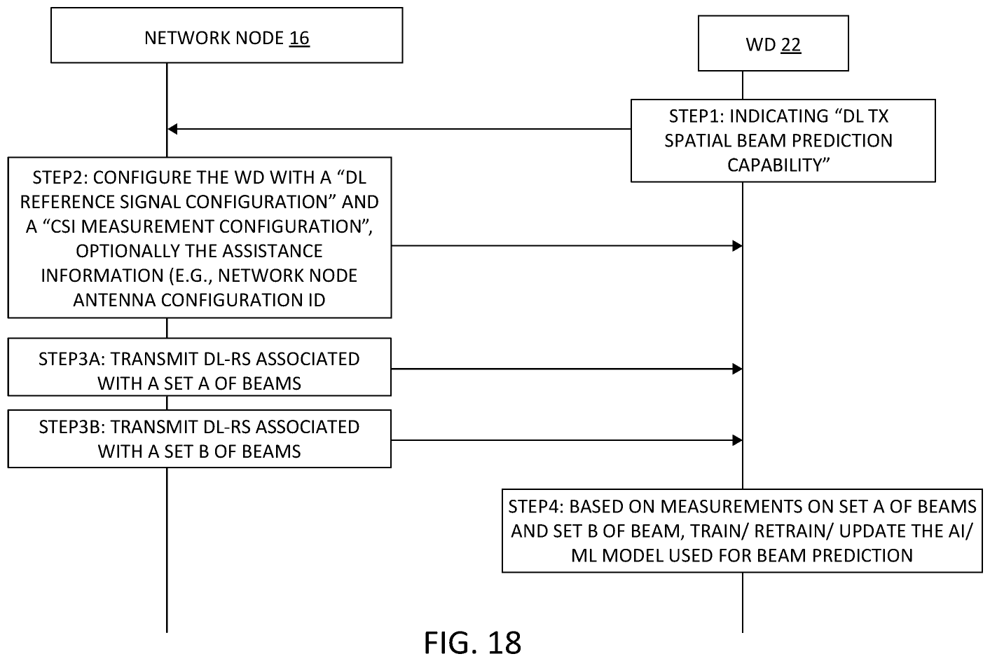

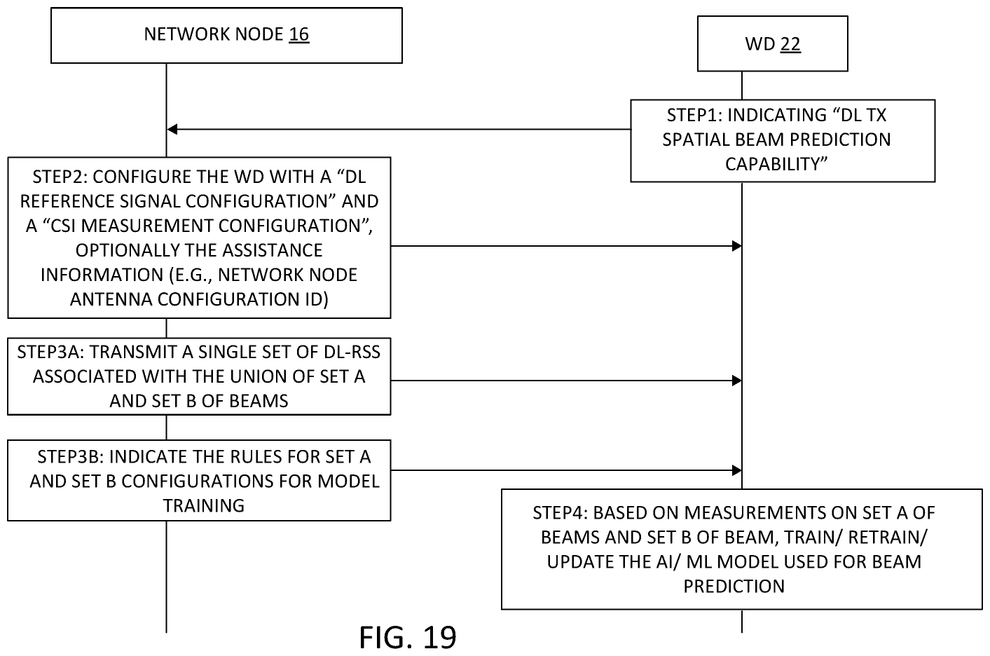

FIG. 18 and FIG. 19 illustrate two flowcharts of data collection according to some embodiments of the present disclosure, where the AI/ML model is trained at the wireless device 22 side.

Referring to FIG. 18 and FIG. 19, in Step 1 of both flowcharts, the wireless device reports, for example during wireless device 22 capability signaling (“Data collection for DL TX spatial beam prediction capability”), support for performing data collection of spatial beam prediction from a Set A of a network node 16 (e.g., gNB) beams based on measurements on a Set B of wireless device 22 beams.

In Step 2 of both FIG. 18 and FIG. 19, the wireless device 22 indicates the relevant configurations for the spatial beam prediction, for example a “DL reference signal configuration”, a “CSI measurement configuration”, a “gNB TX beam assistance information”, etc. The “DL reference signal configuration” may, for example, include of one or more of
A resource Setting (e.g., CSI-ResourceConfig);
CSI-RS resource sets (e.g., NZP-CSI-RS-ResourceSet);
SSB resource sets (e.g., CSI-SSB-ResourceSet);
CSI-RS resources (e.g., NZP-CSI-RS-Resource);
DL-RS resource configurations for 6G; and
Network Node Antenna configuration ID associated with the antenna configuration and/or network node 16 beam configuration (including, e.g., “DL-RS ID to gNB TX beam”-mapping).

“CSI report configuration” may, for example, include of one or more of:
Report Setting (e.g., CSI-ReportConfig); and
CSI report configurations for 6G.

The “gNB TX beam assistance information” may, for example, include of one or more of:
Spatial correlation between different network node 16 Tx beams of Set A and/or Set B of beams;
QCL association between different network node 16 TX beams of Set A and/or Set B of beams;
Azimuth and elevation pointing angle of different network node 16 TX beams of Set A and/or Set B of beams; and
Beamwidth for different network node 16 TX beams of Set A and/or Set B of beams.

In some embodiments, as shown in the example of FIG. 18, in Step 3a and Step 3b, the network node 16 performs a Set A and Set B beam sweep by transmitting a set of DL reference signals associated with the Set A and Set B of beams.

In Step 4 of FIG. 18, the wireless device 22 performs measurements on the Set A and Set B of beams and uses these measurements to create training data set(s) to train/retrain/update an AI/ML model for network node 16 TX beam prediction.

In some embodiments, as shown in Steps 3a and 3b of the example of FIG. 19, the network node 16 may perform a single set of DL-RS transmissions that includes DL-RSs associated to all Set A and Set B beams, and in addition, the network node 16 may indicate to the wireless device about the rules/parameters for creating data sets associated to Set A and Set B, respectively, for model training. Then, in Step 4 of the example of FIG. 19, the wireless device performs measurements on the single set of DL-RSs and uses the rules/parameters to create proper data sets for model training.

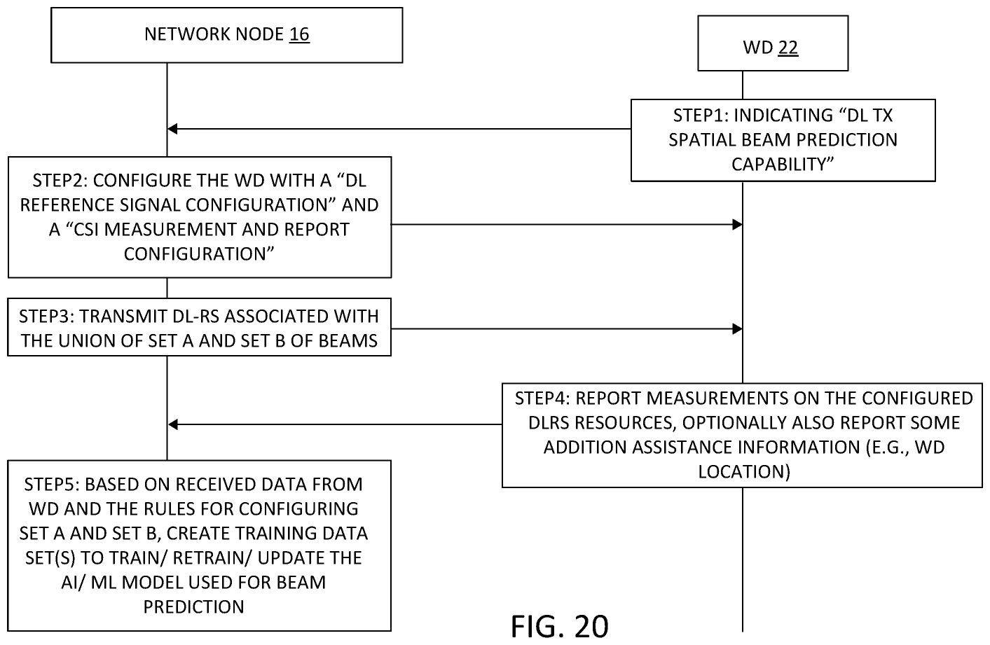

FIG. 20 is a flowchart describing another example embodiment for data collection for the cases where the AI/ML model is trained at the network node 16 side. In Step 1, the wireless device 22 indicates to the network node 16 a capability indication, such as a “DL TX spatial beam prediction capability”. In Step 2, the network node 16 configures the wireless device 22 (e.g., by transmitting control signaling to wireless device 22 including/indicating the configuration) with a “DL reference signal configuration” and a “CSI measurement and report configuration”. In Step 3, the network node 16 transmits DL-RS associated with the union of Set A and Set B of beams to wireless device 22. In Step 4, the wireless device 22 measures and reports measurements on the configured DL-RS resources. Optionally, the wireless device 22 also reports some additional assistance information, such as wireless device 22 location. In Step 5, the network node 16, based on the received data/measurements from the wireless device 22 and the rules/parameters for configuring Set A and Set B, creates/generates/determines training data set(s) to train/retrain/update the AI/ML model used for beam prediction.

### SOME EXAMPLES

Example X1. A method in a wireless device 22 for collecting data for training an AI/ML model capable of predicting one or more (e.g., the best or K-best) beams, associated to one or more DL reference signal(s) which are transmitted by the network (e.g., network node 16), the method comprising:
a. receiving a message containing a DL reference signal configuration, wherein the DL reference signal configuration, configures two or more reference signal resources,
b. receiving a message containing a CSI Report configuration, wherein the CSI Report configuration is associated with the DL reference signal configuration; and
c. receiving a trigger message to measure according to the CSI Report configuration; and
d. perform one or more CSI measurements.

Example X2. The method of Example X1, wherein the DL reference signal configuration configures two sets, wherein each set contains configurations for DL-RS resources.
a. Each DL-RS resource, or simply DL RS, is transmitted in a spatial direction (e.g., using a spatial domain filter) so that different DL-RS resources may correspond to different beams.
b. In this case the wireless device 22 is being configured to perform CSI measurements on both sets, and provide these CSI measurements to the entity (e.g., a wireless device 22, a network node 16, or a computer server) that performs the AI/ML model training for spatial domain prediction.
c. In one option a resource set is configured as a periodic resource, with a configured periodicity. This allows the wireless device 22 to have them available periodically to perform the measurements.
d. In one option a resource set is configured as an aperiodic resource. This allows the wireless device 22 to have them activated (e.g., via MAC CE and/or DCI) when training is needed, without the need to re-configure the wireless device 22 with an RRC Reconfiguration message.
e. In one option a resource set is configured as a semi-persistent aperiodic resource, with a configured periodicity. As in the aperiodic case, this allows the wireless device 22 to have them activated (e.g., via MAC CE and/or DCI) when training is needed, without the need to re-configure the wireless device 22 with an RRC Reconfiguration message, and to start the periodic transmission assuming the wireless device 22 would require a number of transmissions before it may complete the training.

Example X3. The method of Example X2, wherein the DL reference signal configuration consists of configurations of two CSI-RS resource sets, where a first CSI-RS resource set consists of M CSI-RS resources, and a second CSI-RS resource set consists of N CSI-RS resources.

Example X4. The method of Example X2, wherein the DL reference signal configuration consists of configurations of one CSI-RS resource set and one SSB resource set, where the CSI-RS resource set consists of M CSI-RS resources, and the SSB resource set consists of N.

Example X5. The method of Example X2, wherein the DL reference signal configuration consists of configurations of two SSB resource sets, where a first SSB resource set consists of M SSBs, and a second SSB resource set consists of N SSBs.

Example X6. The method of Example X2, wherein each of the sets contains one or more sub-sets, wherein a sub-set contains configurations for one-type of reference signal resource, wherein types of reference signals are SSB or CSI-RS.

Example X7. The method of Example X2, wherein the wireless device 22 performs one or more CSI measurements (e.g., SS-RSRP, L1 RSRP for SSBs, CSI-RSRP, L1 RSRP for CSI-RSs) based on the DL reference signal configuration configuring the two sets, wherein each set contains configurations for DL-RS resources.

Example X8. The method of Example X2, wherein the wireless device 22 provides the one or more CSI measurements (e.g., SS-RSRP, L1 RSRP for SSBs, CSI-RSRP, L1 RSRP for CSI-RSs) performed on the two sets (configured in the DL reference signal configuration) to the AI/ML function responsible for performing spatial-domain prediction(s).

Example X9. The method of any one of Examples X2-X8, wherein the first set (set A) contains the reference signal(s) that the wireless device 22 shall be able to derive the best k predicted reference signal from and the second set (set B) contains the reference signal(s) on which the wireless device 22 can measure on during inference.

Example X10. The method of Example X9, wherein there is a relationship between the maximum and minimum possible reference signals within Set A and Set B, wherein the relationship will set limits on the possible values that the wireless device 22 can be configured with.

Example X11. The method of Example X9, wherein the set A and B is either mutual exclusive or overlapping.

Example X12. The method of Example X9, wherein the Set B of beams could be a subset of Set A of beams. If Set A of beams consist of SSB beams, then Set B of beams are parts of SSB beams in Set A of beams. If Set A of beams consist of CSI-RS beams, then Set B of beams are parts of CSI-RS beams in Set A of beams. If Set A of beams consist of a mix of CSI-RS beams and SSB beams, then Set B of beams could be one of the following:
a. part of CSI-RS beams in Set A of beams
b. part of SSB beams in Set A of beams
c. a mix of part of CSI-RS and SSB beams in Set A of beams

Example X13. The method of Example X1, the wireless device 22 reports the best Y measured reference signal(s) from either one of the sets or both sets that are configured in the DL reference signal configuration.

Example X14. The method of Example X2, wherein the CSI Report configuration contains a field Report setting, wherein the Report setting is associated with the two DL-RS reference signal resource sets.

Example X15. The method of Example X1, wherein the CSI Report configuration contains a field report quantity, wherein the report quantity is set to ‘none’.

Example X16. The method of Example 15, wherein Report Quantity is set to ‘none’ indicates one or more of the following, that the wireless device 22 shall not report measurement to the network node 16 (e.g., gNB) or that the wireless device 22 shall report measurement on the network node 16 (e.g., gNB) for the purpose of data collection.

Example X17. The method of Example X1, wherein the CSI Report configuration contains a field report Quantity, wherein the report quantity indicates that the associated measurements can be used for data collection of beam prediction.

Example X18. The method of Example X1, wherein the CSI Report configuration contains a field indicating that the measurement should be reported to a network node 16.

Example X19. The method of Example X2, wherein the CSI Report configuration, wherein report quantity indicates that the wireless device 22 shall report to the network node 16, the Y best measured reference signals from the first set and/or the second set.

Example X20. The method of Example X1, wherein the CSI Report configuration includes a field “Network node 16 Antenna Configuration ID”, wherein the “Network node 16 Antenna Configuration ID” indicates a number that indicates a certain antenna configuration and/or beam configuration at the network node 16 to associate the training data with.

Example X21. The method of Example X1, wherein the wireless device 22 sends a wireless device 22 capability to a network node 16 16 indicating support for DL TX beam prediction capability, wherein the DL TX beam prediction capability indicates one or more of the following:
a. ability to collect data for training of the beam prediction i.e., indicating that the wireless device 22 is able to perform spatial-domain prediction of a set of beams based on CSI measurements of another set of beams.
b. limitations on relationship between number of reference signals within Set A and Set B
c. AI/ML model processing capability
d. indication of Network node 16 Antenna Configuration IDs that the wireless device 22 needs training data for or does not need training data for
e. indication of one or more RS types which are to be measured and which may be predicted based on the measured one, e.g., Measured DL RS of type B, predicted DL RS type A->indicates that based on DL RS type B measurements the wireless device 22 is able to predict type A DL RS measurements. For example:
   i. Measured SSBs, predicted SSBs
   ii. Measured SSBs, predicted CSI-RSs
   iii. Measured CSI-RSs, predicted SSBs
   iv. Measured CSI-RSs, predicted CSI-RS
   v. Measured CSI-RSs+SSBs, predicted SSBs
   vi. Measured CSI-RSs+SSBs, predicted CSI-RSs
   vii. Measured SSBs, predicted SSBs+CSI-RS
   viii. Measured CSI-RSs, predicted SSBs+CSI-RS
   ix. Measured CSI-RSs+SSBs, predicted SSBs +CSI-RS
f. indicating that the wireless device 22 is able to perform spatial-domain prediction of a set of beams based on CSI measurements of another set of beams, but that the AI/ML model requires training.
g. indicating that the wireless device 22 is able to perform spatial-domain prediction of a set of beams based on CSI measurements of another set of beams, but that the AI/ML model requires assistance for the network for training.
h. indicating that the wireless device 22 is able to perform spatial-domain prediction of a set A of beams from a serving cell 18 which is different from the serving cell 18 of the set B of beams to be measured during inference.
i. indicating that the wireless device 22 is able to perform spatial-domain prediction of a set A of beams from a serving cell 18 which is the same serving cell 18 of the set B of beams to be measured during inference.
j. Indicating that the wireless device 22 is able to perform spatial-domain prediction on a set A of beams from a serving cell 18 which is operating on another carrier than the set B of beams transmitted from another cell 18 to be measured during inference.

Example X22. The method of Example X1, wherein the wireless device 22 receives beam assistance information indicating spatial correlation and/or QCL relation between two (or more) reference signals belonging to any of the two sets or included in different sets.

Example X23. The method of Example X22, wherein there is relationship between the number of reference signals in each set and there corresponding spatial correlation and/or QCL relation.

Example X24. The method of Example X1, wherein the wireless device 22 requests NW assistance in data collection.

Example X25. The method of any one of Examples X18, X19, and X20, wherein the network node 16 is at least one of the following: eNB, gNB, IAB, or base station.

Example X26. The method of Example X1, wherein the wireless device 22 indicates to the network node 16 (transmitting DL RS for data collection for AI/ML training) that data collection is over e.g., when the wireless device 22 finishes the AI/ML model training. In response the wireless device 22 receives from the network an indication that the network has stopped transmitting the sets of DL RSs and an indication to deactivate (e.g., MAC CE and/or DCI) and/or to remove the DL RS resource sets at the wireless device 22 (e.g., an RRC Reconfiguration message).

### EXAMPLES

Example A1. A network node 16 configured to communicate with a wireless device 22 (wireless device 22), the network node 16 configured to, and/or comprising a radio interface and/or comprising processing circuitry configured:
determine a reference signal configuration configuring a plurality of reference signal resources including at least one first reference signal resource and at least one second reference signal resource;
determine a measurement report configuration associated with the plurality of reference signal resources;
cause transmission to the wireless device 22 of the reference signal configuration;
cause transmission to the wireless device 22 of the measurement report configuration, the transmission of the measurement report configuration being configured to cause the wireless device 22 to perform measurements on at least one first reference signal resource of the plurality of reference signal resources;
receive, from the wireless device 22, a measurement report based on the measurement report configuration and at least one predicted signal metric for the at least one second reference signal resource, the at least one predicted signal metric being based on a machine learning (ML) model; and
optionally, perform at least one network node 16 action based on the received measurement report.

Example A2. The network node 16 of Example A1, wherein the at least one first reference signal resource is associated with a first spatial direction, the at least one second reference signal resource being associated with a second spatial direction different from the first spatial direction.

Example A3. The network node 16 of any one of Examples A1 and A2, wherein the at least one first reference signal resource is associated with a first set of beams, the at least one second reference signal resource being associated with a second set of beams different from the first set of beams.

Example A4. The network node 16 of Example A3, wherein the first set of beams includes at least one narrow beam, the second set of beams including at least one wide beam.

Example A5. The network node 16 of Example A4, wherein the first set of beams includes only narrow beams, the second set of beams including only wide beams.

Example A6. The network node 16 of Example A5, wherein the first set of beams includes at least one wide beam, the second set of beams including at least one narrow beam.

Example A7. The network node 16 of Example A6, wherein the first set of beams includes only wide beams, the second set of beams including only narrow beams.

Example A8. The network node 16 of any one of Examples A1-A7, wherein:
the processing circuitry is further configured to:
   receive, from the wireless device 22, a prediction request; and
at least one of:
   the determining of the reference signal configuration being based at least on the prediction request; and
   the determining of the measurement report configuration being based at least on the prediction request.

Example A9. The network node 16 of Example A8, wherein the prediction request indicates at least one of:
the at least one first reference signal resource to be measured;
the at least one second reference signal resource to be predicted;
a ML model processing capability;
a prediction capability;
a limitation on a relationship between a first number of the at least one of first reference signal resources and a second number of the at least one second reference signal resources;
at least one network node 16 antenna for training and/or measuring; and
a request for assistance from the network node 16 for the training of the ML model.

Example A10. The network node 16 of any one of Examples A1-A9, wherein the at least one first reference signal resource is associated with a first cell, the at least one second reference signal resource being associated with a second cell different from the first cell.

Example A11. The network node 16 of Example A10, wherein the wireless device is configured with a dual connectivity configuration, the first cell being a secondary cell of the dual connectivity configuration, the first cell being a secondary cell of the dual connectivity configuration.

Example A12. The network node 16 of any one of Examples A1-A11, wherein:
the processing circuitry is further configured to:
cause transmission, to the wireless device 22, of an indication indicating a spatial correlation and/or quasi-co-location (QCL) relation between the at least one first reference signal resource and the at least one second reference signal resource; and
the training of the ML model being further based on the spatial correlation and/or the QCL relation.

Example A13. The network node 16 of any one of Examples A1-A12, wherein:
the processing circuitry is further configured to:
receive, from the wireless device 22, a first indication that the training of the ML model is complete;
in response to the first indication, stop transmission of at least one of the at least one first reference signal resource and the at least one second reference signal resource; and
cause transmission of a second indication to the wireless device 22 indicating the stopping, the second indication being configured to cause the wireless device 22 to deactivate and/or remove the at least one first reference signal resource and/or the at least one second reference signal resource.

Example A14. The network node 16 of any one of Examples A1-A13, wherein the processing circuitry is further configured to:
determine that the wireless device 22 has moved from a first location to a second location; and
based on the determination, cause transmission of an indication to the wireless device 22 to retrain the ML model using at least one additional measurement of the at least one first reference signal resource measured at the second location.

Example A15. The network node 16 of any one of Examples A1-A14, wherein:
the at least one first reference signal resource includes at least one of:
   a synchronization signal block (SSB);
   a channel state information reference signal (CSI-RS);
   a cell-specific reference signal (CRS);
   a discovery reference signal (DRS); and
   a demodulation reference signal (DMRS); and
the at least one second reference signal resource includes at least one of:
   an SSB;
   a CSI-RS;
   a CRS;
   a DRS; and
   a DMRS.

Example B1. A method implemented in a network node 16, the method comprising:
determining a reference signal configuration configuring a plurality of reference signal resources including at least one first reference signal resource and at least one second reference signal resource;
determining a measurement report configuration associated with the plurality of reference signal resources;
causing transmission to the wireless device 22 of the reference signal configuration;
causing transmission to the wireless device 22 of the measurement report configuration, the transmission of the measurement report configuration being configured to cause the wireless device 22 to perform measurements on at least one first reference signal resource of the plurality of reference signal resources;
receiving, from the wireless device 22, a measurement report based on the measurement report configuration and at least one predicted signal metric for the at least one second reference signal resource, the at least one predicted signal metric being based on a machine learning (ML) model; and
optionally, performing at least one network node 16 action based on the received measurement report.

Example B2. The method of Example B1, wherein the at least one first reference signal resource is associated with a first spatial direction, the at least one second reference signal resource being associated with a second spatial direction different from the first spatial direction.

Example B3. The method of any one of Examples B1 and B2, wherein the at least one first reference signal resource is associated with a first set of beams, the at least one second reference signal resource being associated with a second set of beams different from the first set of beams.

Example B4. The method of Example B3, wherein the first set of beams includes at least one narrow beam, the second set of beams including at least one wide beam.

Example B5. The method of Example B4, wherein the first set of beams includes only narrow beams, the second set of beams including only wide beams.

Example B6. The method of Example B5, wherein the first set of beams includes at least one wide beam, the second set of beams including at least one narrow beam.

Example B7. The method of Example B6, wherein the first set of beams includes only wide beams, the second set of beams including only narrow beams.

Example B8. The method of any one of Examples B1-B7, wherein:
the method further comprises:
   receiving, from the wireless device 22, a prediction request; and
at least one of:
   the determining of the reference signal configuration being based at least on the prediction request; and
   the determining of the measurement report configuration being based at least on the prediction request.

Example B9. The method of Example B8, wherein the prediction request indicates at least one of:
the at least one first reference signal resource to be measured;
the at least one second reference signal resource to be predicted;
a ML model processing capability;
a prediction capability;
a limitation on a relationship between a first number of the at least one of first reference signal resources and a second number of the at least one second reference signal resources;
at least one network node 16 antenna for training and/or measuring; and
a request for assistance from the network node 16 for the training of the ML model.

Example B10. The method of any one of Examples B1-B9, wherein the at least one first reference signal resource is associated with a first cell, the at least one second reference signal resource being associated with a second cell different from the first cell.

Example B11. The method of Example B10, wherein the wireless device 22 is configured with a dual connectivity configuration, the first cell being a secondary cell of the dual connectivity configuration, the first cell being a secondary cell of the dual connectivity configuration.

Example B12. The method of any one of Examples B1-B11, wherein:
the method further comprises:
   causing transmission, to the wireless device 22, of an indication indicating a spatial correlation and/or quasi-co-location (QCL) relation between the at least one first reference signal resource and the at least one second reference signal resource; and
the training of the ML model being further based on the spatial correlation and/or the QCL relation.

Example B13. The method of any one of Examples B1-B12, wherein:
the method further comprises:
   receiving, from the wireless device 22, a first indication that the training of the ML model is complete;
   in response to the first indication, stopping transmission of at least one of the at least one first reference signal resource and the at least one second reference signal resource; and
   causing transmission of a second indication to the wireless device 22 indicating the stopping, the second indication being configured to cause the wireless device 22 to deactivate and/or remove the at least one first reference signal resource and/or the at least one second reference signal resource.

Example B14. The method of any one of Examples B1-B13, wherein the method further comprises:
determining that the wireless device 22 has moved from a first location to a second location; and
based on the determination, causing transmission of an indication to the wireless device 22 to retrain the ML model using at least one additional measurement of the at least one first reference signal resource measured at the second location.

Example B15. The method of any one of Examples B1-B14, wherein:
the at least one first reference signal resource includes at least one of:
   a synchronization signal block (SSB);
   a channel state information reference signal (CSI-RS);
   a cell-specific reference signal (CRS);
   a discovery reference signal (DRS); and
   a demodulation reference signal (DMRS); and
the at least one second reference signal resource includes at least one of:
   an SSB;
   a CSI-RS;
   a CRS;
   a DRS; and
   a DMRS.

Example C1. A wireless device 22 (wireless device 22) configured to communicate with a network node 16, the wireless device 22 configured to, and/or comprising a radio interface and/or processing circuitry configured to:
receive a reference signal configuration configuring a plurality of reference signal resources;
receive a measurement report configuration associated with the plurality of reference signal resources;
perform measurements on at least one first reference signal resource of the plurality of reference signal resources based on the measurement report configuration;
train a machine learning (ML) model based on the measurements; and
determine at least one predicted signal metric for at least one second reference signal resource of the plurality of reference signal resources based on the trained ML model.

Example C2. The wireless device 22 of Example C1, wherein the processing circuitry is further configured to:
determine a measurement report based on the measurement report configuration and the at least one predicted signal metric for the at least one second reference signal resource; and
cause transmission of the measurement report to the network node 16.

Example C3. The wireless device 22 of any one of Examples C1 and C2, wherein the at least one first reference signal resource is associated with a first spatial direction, the at least one second reference signal resource being associated with a second spatial direction different from the first spatial direction.

Example C4. The wireless device 22 of any one of Examples C1-C3, wherein the at least one first reference signal resource is associated with a first set of beams, the at least one second reference signal resource being associated with a second set of beams different from the first set of beams.

Example C5. The wireless device 22 of Example C4, wherein the first set of beams includes at least one narrow beam, the second set of beams including at least one wide beam.

Example C6. The wireless device 22 of Example C5, wherein the first set of beams includes only narrow beams, the second set of beams including only wide beams. Example C7. The wireless device 22 of Example C4, wherein the first set of beams includes at least one wide beam, the second set of beams including at least one narrow beam.

Example C8. The wireless device 22 of Example C7, wherein the first set of beams includes only wide beams, the second set of beams including only narrow beams.

Example C9. The wireless device 22 of any one of Examples C1-C8, wherein: the processing circuitry is further configured to:
cause transmission to the network node 16 of a prediction request; and
at least one of:
   the receiving of the reference signal configuration being based at least on the prediction request; and
   the receiving of the measurement report configuration being based at least on the prediction request.

Example C10. The wireless device 22 of Example C9, wherein the prediction request indicates at least one of:
the at least one first reference signal resource to be measured;
the at least one second reference signal resource to be predicted;
a ML model processing capability;
a prediction capability;
a limitation on a relationship between a first number of the at least one of first reference signal resources and a second number of the at least one second reference signal resources;
at least one network node 16 antenna for training and/or measuring; and
a request for assistance from the network node 16 for the training of the ML model.

Example C11. The wireless device 22 of any one of Examples C1-C10, wherein the at least one first reference signal resource is associated with a first cell, the at least one second reference signal resource being associated with a second cell different from the first cell.

Example C12. The wireless device 22 of Example C11, wherein the wireless device 22 is configured with a dual connectivity configuration, the first cell being a secondary cell of the dual connectivity configuration, the first cell being a secondary cell of the dual connectivity configuration.

Example C13. The wireless device 22 of any one of Examples C1-C12, wherein: the processing circuitry is further configured to:
receive an indication indicating a spatial correlation and/or quasi-co-location (QCL) relation between the at least one first reference signal resource and the at least one second reference signal resource; and
the training of the ML model being further based on the spatial correlation and/or the QCL relation.

Example C14. The wireless device 22 of any one of Examples C1-C13, wherein: the processing circuitry is further configured to:
cause transmission to the network node 16 of a first indication that the training of the ML model is complete;
in response to the first indication, receive a second indication from the network node 16 indicating that the network node 16 has stopped transmitting at least one of the at least one first reference signal resource and the at least one second reference signal resource;
in response to the second indication, deactivate and/or remove the at least one first reference signal resource and/or the at least one second reference signal resource.

Example C15. The wireless device 22 of any one of Examples C1-C14, wherein the processing circuitry is further configured to:
determine that the wireless device 22 has moved from a first location to a second location; and
based on the determination, retrain the ML model using at least one additional measurement of the at least one first reference signal resource measured at the second location.

Example C16. The wireless device 22 of any one of Examples C1-C15, wherein:
the at least one first reference signal resource includes at least one of:
   a synchronization signal block (SSB);
   a channel state information reference signal (CSI-RS);
   a cell-specific reference signal (CRS);
   a discovery reference signal (DRS); and
   a demodulation reference signal (DMRS); and
the at least one second reference signal resource includes at least one of:
   an SSB;
   a CSI-RS;
   a CRS;
   a DRS; and
   a DMRS

Example D1. A method implemented in a wireless device 22 (wireless device 22) in communication with a network node 16, the method comprising:
receiving a reference signal configuration configuring a plurality of reference signal resources;
receiving a measurement report configuration associated with the plurality of reference signal resources;
performing measurements on at least one first reference signal resource of the plurality of reference signal resources based on the measurement report configuration;
training a machine learning (ML) model based on the measurements; and
determining at least one predicted signal metric for at least one second reference signal resource of the plurality of reference signal resources based on the trained ML model.

Example D2. The method of Example D1, further comprising:
determining a measurement report based on the measurement report configuration and the at least one predicted signal metric for the at least one second reference signal resource; and
causing transmission of the measurement report to the network node 16.

Example D3. The method of any one of Examples D1 and D2, wherein the at least one first reference signal resource is associated with a first spatial direction, the at least one second reference signal resource being associated with a second spatial direction different from the first spatial direction.

Example D4. The method of any one of Examples DI-D3, wherein the at least one first reference signal resource is associated with a first set of beams, the at least one second reference signal resource being associated with a second set of beams different from the first set of beams.

Example D5. The method of Example D4, wherein the first set of beams includes at least one narrow beam, the second set of beams including at least one wide beam.

Example D6. The method of Example D5, wherein the first set of beams includes only narrow beams, the second set of beams including only wide beams.

Example D7. The method of Example D4, wherein the first set of beams includes at least one wide beam, the second set of beams including at least one narrow beam.

Example D8. The method of Example D7, wherein the first set of beams includes only wide beams, the second set of beams including only narrow beams.

Example D9. The method of any one of Examples D1-D8, further comprising:
causing transmission to the network node 16 of a prediction request; and
at least one of:
   the receiving of the reference signal configuration being based at least on the prediction request; and
   the receiving of the measurement report configuration being based at least on the prediction request.

Example D10. The method of Example D9, wherein the prediction request indicates at least one of:
the at least one first reference signal resource to be measured;
the at least one second reference signal resource to be predicted;
a ML model processing capability;
a prediction capability;
a limitation on a relationship between a first number of the at least one of first reference signal resources and a second number of the at least one second reference signal resources;
at least one network node 16 antenna for training and/or measuring; and
a request for assistance from the network node 16 for the training of the ML model.

Example D11. The method of any one of Examples DI-D10, wherein the at least one first reference signal resource is associated with a first cell, the at least one second reference signal resource being associated with a second cell different from the first cell.

Example D12. The method of Example D11, wherein the wireless device 22 is configured with a dual connectivity configuration, the first cell being a secondary cell of the dual connectivity configuration, the second cell being a primary cell of the dual connectivity configuration.

Example D13. The method of any one of Examples D1-D12, further comprising:
receiving an indication indicating a spatial correlation and/or quasi-Do-location (QCL) relation between the at least one first reference signal resource and the at least one second reference signal resource; and
the training of the ML model being further based on the spatial correlation and/or the QCL relation.

Example D14. The method of any one of Examples DI-D13, further comprising:
causing transmission to the network node 16 of a first indication that the training of the ML model is complete;
in response to the first indication, receiving a second indication from the network node 16 indicating that the network node 16 has stopped transmitting at least one of the at least one first reference signal resource and the at least one second reference signal resource;
in response to the second indication, deactivating and/or removing the at least one first reference signal resource and/or the at least one second reference signal resource.

Example D15. The method of any one of Examples DI-D14, further comprising:
determining that the wireless device 22 has moved from a first location to a second location; and
based on the determination, retraining the ML model using at least one additional measurement of the at least one first reference signal resource measured at the second location.

Example D16. The method of any one of Examples D1-D15, wherein:
the at least one first reference signal resource includes at least one of:
   a synchronization signal block (SSB);
   a channel state information reference signal (CSI-RS);
   a cell-specific reference signal (CRS);
   a discovery reference signal (DRS); and
   a demodulation reference signal (DMRS); and
the at least one second reference signal resource includes at least one of:
   an SSB;
   a CSI-RS;
   a CRS;
   a DRS; and
   a DMRS.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:
3GPP 3rd Generation Partnership Project
5G Fifth Generation
ACK Acknowledgement
AI Artificial Intelligence
AoA Angle of Arrival
CORESET Control Resource Set
CSI Channel State Information
CSI-RS CSI Reference Signal
DCI Downlink Control Information
DoA Direction of Arrival
DL Downlink
DMRS Downlink Demodulation Reference Signals
FDD Frequency-Division Duplex
FR2 Frequency Range 2
HARQ Hybrid Automatic Repeat Request
ID identity
gNB gNodeB
MAC Medium Access Control
MAC-CE MAC Control Element
ML Machine Learning
NR New Radio
NW Network
OFDM Orthogonal Frequency Division Multiplexing
PBCH Physical Broadcast Channel
PCI Physical Cell Identity
PDCCH Physical Downlink Control Channel
PDSCH Physical Downlink Shared Channel
PRB Physical Resource Block
QCL Quasi co-located
RB Resource Block
RRC Radio Resource Control
RSRP Reference Signal Strength Indicator
RSRQ Reference Signal Received Quality
RSSI Received Signal Strength Indicator
SCS Subcarrier Spacing
SINR Signal to Interference plus Noise Ratio
SSB Synchronization Signal Block
RL Reinforcement Learning
RS Reference Signal
Rx Receiver
TB Transport Block
TDD Time-Division Duplex
TCI Transmission configuration indication
TRP Transmission/Reception Point
Tx Transmitter
UE User Equipment
UL Uplink

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A wireless device configured to communicate with a network node the wireless device configured to:
perform measurements on at least one first reference signal resource and at least one second reference signal of a plurality of reference signal resources indicated by a reference signal configuration, the measurements being performed based on a measurement report configuration associated with the plurality of reference signal resources; and
store the measurements for at least one of training and monitoring a machine learning, ML, model configured to predict at least one of at least one best beam and at least one K-best beam associated with at least one downlink, DL, reference signal transmitted by the network node.

2.-10. (canceled)

11. The wireless device of claim 1, further configured to:
cause transmission to the network node of a data collection request; and
at least one of:
the signal configuration being received based at least on the data collection request; or
the measurement report configuration being received based at least on the data collection request.

12. The wireless device of claim 11, wherein the data collection request indicates at least one of:
the at least one first reference signal resource to be measured;
the at least one second reference signal resource to be predicted;
a machine learning, ML, model processing capability;
a prediction capability;
a limitation on a relationship between a first number of the at least one of first reference signal resources and a second number of the at least one second reference signal resources;
at least one network node antenna configuration for data collection; or
a request for assistance from the network node for training of the ML model.

13. The wireless device of claim 1, wherein the at least one first reference signal resource is associated with a first cell, and the at least one second reference signal resource is associated with a second cell different from the first cell.

14. The wireless device of claim 13, wherein the wireless device is configured with a dual connectivity configuration, the first cell being a secondary cell, SCell, of the dual connectivity configuration, the first cell being a special cell, sPCell, of the dual connectivity configuration.

15. The wireless device of claim 1, wherein the at least one first reference signal resource is associated with a first cell, and the at least one second reference signal resource is associated with the first cell.

16. The wireless device of claim 11, further configured to:
receive an indication indicating at least one of a spatial correlation or quasi-co-location, QCL, relation between the at least one first reference signal resource and the at least one second reference signal resource; and
the training of the ML model being further based on at least one of the spatial correlation or the QCL relation.

17. The wireless device of claim 1, further configured to:
cause transmission to the network node of a first indication that the training of the ML model is complete;
in response to the first indication, receive a second indication from the network node indicating that the network node has stopped transmitting at least one of the at least one first reference signal resource or the at least one second reference signal resource; and
in response to the second indication, at least one of deactivate and remove at least one of the at least one first reference signal resource or the at least one second reference signal resource.

18. The wireless device of claim 1, further configured to:
determine that the wireless device has moved from a first location to a second location; and
based on the determination, retrain the ML model using at least one additional measurement of the at least one first reference signal resource measured at the second location.

19.-21. (canceled)

22. A method performed by a wireless device, the method comprising:
performing measurements on at least one first reference signal resource and at least one second reference signal of a plurality of reference signal resources indicated by a reference signal configuration, the measurements being performed based on a measurement report configuration associated with the plurality of reference signal resources;
storing the measurements for at least one of training and monitoring a machine learning, ML, model configured to predict at least one of at least one best beam and at least one K-best beam associated with at least one downlink, DL, reference signal transmitted by the network node.

23.-25. (canceled)

26. The method of claim 22, wherein the at least one first reference signal resource belongs to a first reference signal resource set, which is associated with a first set of beams, and the at least one second reference signal resource belongs to a second reference signal resource set, which is associated with a second set of beams different from the first set of beams.

27. The method of claim 22, wherein the measurement report contains one of the best Y reference signal or the best Y reference signals with the highest RSRP values from the first reference signal resource set, the second reference signal resource set, or both.

28. The method of claim 26, wherein the first set of beams includes at least one narrow beam, and the second set of beams includes at least one wide beam that is spatially wider than the at least one narrow beam.

29. The method of claim 28, wherein the first set of beams includes only narrow beams, and the second set of beams includes only wide beams; or
wherein the first set of beams includes at least one wide beam, and the second set of beams includes at least one narrow beam.

30. (canceled)

31. (canceled)

32. The method of claim 22, further comprising:
causing transmission to the network node of a data collection request; and
at least one of:
the signal configuration being received based at least on the data collection request; or
the measurement report configuration being received based at least on the data collection request.

33. The method of claim 32, wherein the data collection request indicates at least one of:
the at least one first reference signal resource to be measured;
the at least one second reference signal resource to be predicted;
a machine learning, ML, model processing capability;
a prediction capability;
a limitation on a relationship between a first number of the at least one of first reference signal resources and a second number of the at least one second reference signal resources;
at least one network node antenna configuration for data collection; or
a request for assistance from the network node for training of the ML model.

34. The method of claim 22, wherein the at least one first reference signal resource is associated with a first cell, and the at least one second reference signal resource is associated with a second cell different from the first cell.

35. The method of claim 34, wherein the wireless device is configured with a dual connectivity configuration, the first cell being a secondary cell, SCell, of the dual connectivity configuration, the first cell being a special cell, sPCell, of the dual connectivity configuration.

36.-42. (canceled)

43. A network node configured to communicate with a wireless device, the network node configured to:
transmit a reference signal configuration to the wireless device, the reference signal configuration configuring at least one first reference signal resource and at least one second reference signal of a plurality of reference signal resources indicated by a reference signal configuration; and
receive, from the wireless device, a measurement report including measurements performed based on a measurement report configuration associated with the plurality of reference signal resources, the measurements being used for at least one of training and monitoring a machine learning, ML, model configured to predict at least one of at least one best beam and at least one K-best beam associated with at least one downlink, DL, reference signal transmitted by the network node.

44.-63. (canceled)

64. A method performed by a network node, the method comprising:
transmitting a reference signal configuration to the wireless device, the reference signal configuration configuring at least one first reference signal resource and at least one second reference signal of a plurality of reference signal resources indicated by a reference signal configuration; and
receiving, from the wireless device, a measurement report including measurements performed based on a measurement report configuration associated with the plurality of reference signal resources, the measurements being used for at least one of training and monitoring a machine learning, ML, model configured to predict at least one of at least one best beam and at least one K-best beam associated with at least one downlink, DL, reference signal transmitted by the network node.

65.-84. (canceled)
